(19) United States
(12) Patent Application Publication
(10) Pub. No.: US 2024/0381501 A1
(43) Pub. Date: Nov. 14, 2024

(54) COOKING APPLIANCE AND CONTROL METHOD THEREOF

(71) Applicant: LG ELECTRONICS INC., Seoul (KR)

(72) Inventors: Dong Han KIM, Seoul (KR); Ugjin KIM, Seoul (KR); Dongkwan YU, Seoul (KR)

(73) Assignee: LG ELECTRONICS INC., Seoul (KR)

(21) Appl. No.: 18/691,753

(22) PCT Filed: May 3, 2022
(86) PCT No.: PCT/KR2022/006368

§ 371 Date: Mar. 13, 2024

(30) Foreign Application Priority Data
Oct. 28, 2021 (KR) 10-2021-0146154
Jan. 5, 2022 (KR) 10-2022-0001810

(51) Int. Cl. H05B 6/78; H05B 6/64

(52) U.S. Cl. CPC H05B 6/782; H05B 6/6485

(57) ABSTRACT

The present invention relates to a cooking appliance. The cooking appliance according to the present invention may have a cavity (S) formed inside cases (100 and 200), and a first heat source module (400) which emits microwaves may be disposed on the side surface of the cases (100 and 200). A second heat source module (600) which generates radiant heat may be disposed on the upper portion of the cases (100 and 200). In addition, it is possible to elevate the second heat source module (600), and whether the first heat source module (400) operates may be determined according to whether the second heat source module (600) is elevated.

### TECHNICAL FIELD

The present disclosure relates to a cooking appliance and a control method thereof.

### BACKGROUND ART

Various types of cooking appliances are used to heat food at home or in restaurants. For example, various cooking appliances such as microwave ovens, induction heating electric ranges, and grill heaters are used.

Among these appliances, a microwave oven is a high-frequency heating type of cooking appliance. The microwave oven heats food by using molecules in a high-frequency electric field vibrating strongly to generate heat. The advantage of the microwave oven is heating food evenly in a short time.

An induction heating electric range is a cooking appliance that uses electromagnetic induction to heat an object to be heated. Specifically, when high-frequency power of a predetermined size is applied to a coil, the induction heating electric range generates eddy current in the object to be heated, which is made of a metal substance, using magnetic field└ generated around the coil, and thus heating the object to be heated.

In addition, a grill heater is a cooking appliance that heats food by radiating or convection of infrared heat. The grill heater allows infrared heat to penetrate the food, so that the food can be cooked evenly throughout.

Accordingly, as the cooking appliances using various types of heat sources are released, the number and types of cooking appliances provided to users have increased, and there is a problem in that the cooking appliances occupy a large volume in the living space. Accordingly, a demand of users for a composite cooking appliance having a plurality of heating modules together is increasing. In addition, it is necessary to develop a cooking appliance that uses a plurality of heating methods at the same time so that food in the object to be heated is cooked more uniformly and quickly.

U.S. Pat. No. 6,987,252 B2 (related art 1) disclosed a cooking appliance including a heat source using the radiant heat and convective heat along with microwaves. Korean Patent Application Publication No. 10-2018-0115981 (related art 2) disclosed the cooking appliance, which includes a heat source that uses microwaves, and a heat source that generates radiant heat and convective heat. In addition, Korean Patent Application Publication No. 10-2021-0107487 (related art 3) disclosed a cooking appliance for using microwave and induction heating heat sources at the same time in one device.

However, the related arts 1 to 3 have a limitation in that a technology of changing positions of some heat sources among multiple heat sources to efficiently use the multiple heat sources is not provided. In addition, in a cooking appliance with multiple heat sources, when positions of some heat sources are changed, the change may affect usage of other heat sources, so there is a need to control other heat sources in the unused state.

### DISCLOSURE

### Technical Problem

The present disclosure is intended to provide a cooking appliance with multiple heat sources in which positions of some of the heat sources are changed.

Another objective of the present disclosure is to provide a cooking appliance in which as positions of some of heat sources are changed when food is cooked in the cooking appliance, other heat sources are activated or deactivated.

Yet another objective of the present disclosure is to provide a cooking appliance in which positions of heat sources are changed to allow some of the heat sources to get closer to food in the cavity.

### Technical Solution

A cooking appliance of the present disclosure may include a casing having a cavity therein, and a first heat source module emitting microwaves may be arranged at a side surface of the casing. In addition, a second heat source module emitting radiant heat may be arranged an upper portion of the casing. Furthermore, a processor of the cooking appliance may control operation of the first, second heat source module. In another embodiment, a third heat source module emitting magnetic fields may be arranged at a bottom surface of the casing, and the processor may control operation of the third heat source module.

The second heat source module may be raised and lowered from the upper portion of the casing. To this end, the second heat source module may include a fixed assembly fixed to the upper portion of the casing, a moving assembly with a heating unit emitting radiant heat toward the cavity, and a link assembly connected to the fixed assembly and the moving assembly while being located therebetween and configured to raise and lower the moving assembly. When a raising or lowering command of the moving assembly is input, the processor may operate the link assembly to raise or lower the moving assembly. Accordingly, in the cooking appliance, the moving assembly is lowered to bring the heating unit from the cavity closer to the bottom surface, more preferably, allow the heating unit to get closer to food to reduce a cooking time.

Furthermore, the cooking appliance may include a raising and lowering detection switch to detect raising and lowering of the second heat source module. The raising and lowering detection switch may be securely installed at the upper portion of the casing, and when the moving assembly is raised, the raising and lowering detection switch is pressed by the moving assembly to be turned into an ON state, and when the moving assembly is lowered, the raising and lowering detection switch is released from the pressed state to be turned into an OFF state. The processor may determine whether the moving assembly is raised or lowered according to the ON/OFF state of the raising and lowering detection switch.

Furthermore, when an operation command of the first heat source module is input, the processor may operate the first heat source module only when the raising and lowering detection switch detects raising of the moving assembly. However, even when the operation command of the first heat source module is input, the process may not operate the first heat source module when the raising and lowering detection switch detects lowering of the moving assembly. To this end, when the operation of the first heat source module is input, the processor determines whether or not the second heat source module is raised to a first position, and when the second heat source module is in a raised state, the process may operate the first heat source module. However, when the second heat source module is in a lowered state, the processor does not operate the first heat source module.

Furthermore, when the second heat source module is raised to the first position and waits, when a lowering command of the second heat source module is input, the processor determines whether or not the first heat source module is operated, and when the first heat source module is operated, the process may allow the second heat source module to wait at the first position. However, when the first heat source module is in a non-operated state, the processor lowers the second heat source module. Accordingly, even when the lowering command of the second heat source module is input, when the first heat source module is operated, the second heat source module is not lowered, and is lowered only when operation of the first heat source module is stopped.

Furthermore, while the second heat source module is raised to the first position and waits, and when the lowering command of the second heat source module is input, the processor determines whether or not the first heat source module is operated, and when the first heat source module is in a non-operated state, the processor lowers the second heat source module. However, when the first heat source module is operated, the processor stops operation of the first heat source module, and then lowers the second heat source module. Accordingly, when the lowering command of the second heat source module is input, when the first heat source module is operated, the process may stop operation of the first heat source module and then lower the second heat source module.

Furthermore, while the second heat source module is lowered, when a raising command of the second heat source module is input, the processor raises the second heat source module, and when the second heat source module is raised to the first position, the process may stop raising of the second heat source module. Accordingly, the second heat source module may be returned to the first position and wait.

### Advantageous Effects

The cooking appliance according to the present disclosure has the effects as follows.

According to the present disclosure, the heat sources are respectively arranged at the side surfaces, bottom surface, and upper surface of the cooking appliance without interference therebetween and positions of some of the heat sources can be changed. Accordingly, when food is cooked in the cooking appliance, the food can be efficiently cooked while positions of the heat sources are adjusted.

Furthermore, according to the present disclosure, when positions of some of the heat sources are adjusted to secure the heat source needed to cook food, energy waste due to duplicated usage of the heat sources can be minimized by deactivating other heat sources.

According to the present disclosure, some of the heat sources of the cooking appliance can get closer to food in the cavity, so that the cooking time can be reduced.

### DESCRIPTION OF DRAWINGS

FIG. 1 is a perspective view showing a cooking appliance according to an embodiment of the present disclosure.

FIG. 2 is an exploded-perspective view showing components constituting the cooking appliance according to the embodiment of the present disclosure.

FIG. 3 is an exploded-perspective view showing remaining components of excluding a door, an outer side plate, and an outer upper plate from among components consisting of the cooking appliance according to the embodiment of the present disclosure.

FIG. 4 is an exploded-perspective view showing the structure of FIG. 3 at the opposite angle of FIG. 3.

FIG. 5 is a sectional view taken along line VII-VII′ of FIG. 1.

FIG. 6 is an exploded-perspective view showing components of a third heat source module consisting of the cooking appliance according to the embodiment of the present disclosure.

FIG. 7 is a perspective view showing configuration of a second heat source module constituting the cooking appliance according to the embodiment of the present disclosure.

FIG. 8 is an exploded-perspective view showing components constituting the second heat source module shown in FIG. 7.

FIG. 9 is a perspective view showing the second heat source module in FIG. 7 arranged at a first position.

FIG. 10 is a perspective view showing the second heat source module in FIG. 7 arranged at a second position.

FIG. 11 is a sectional view showing a state where the second heat source module in FIG. 7 is arranged at the first position and a raising and lowering detection switch is pressed by an operation pin.

FIG. 12 is a block diagram showing a connection relationship between a processor and components connected thereto that constitutes the cooking appliance according to the embodiment of the present disclosure.

FIG. 13 is a flowchart showing a control method for the cooking appliance when the second heat source module of the cooking appliance according to the embodiment of the present disclosure is raised and lowered.

FIG. 14 is a flowchart showing a control method for the cooking appliance when the second heat source module of the cooking appliance according to another embodiment of the present disclosure is raised and lowered.

FIG. 15 is a flowchart showing a control method of the cooking appliance when the second heat source module of the cooking appliance according to another embodiment of the present disclosure is raised and lowered.

FIG. 16 is a perspective view showing the cooking appliance according to a second embodiment of the present disclosure.

FIG. 17 is a perspective view showing the cooking appliance according to the second embodiment shown in FIG. 16 at a different angle from FIG. 16.

FIG. 18 is a plan view showing a structure of the second embodiment shown in FIG. 16.

FIG. 19 is a rear view showing a structure of the second embodiment shown in FIG. 16.

FIG. 20 is a left side view showing a structure of the second embodiment shown in FIG. 16.

FIG. 21 is a right side view showing a structure of the second embodiment shown in FIG. 16.

### MODE FOR INVENTION

Hereinbelow, exemplary embodiments of the present disclosure will be described in detail with reference to accompanying drawings. Wherever possible, the same reference numerals will be used throughout the drawings and the description to refer to the same or like elements or parts. Furthermore, it is to be noted that, when detailed description of the functions and configuration of conventional elements related with the present disclosure may make the gist of the present disclosure unclear, a detailed description of those elements will be omitted.

A cooking appliance of the present disclosure is provided to cook food subject to cooking (hereinbelow, which will be referred to as ‘cooked food’) using a plurality of heat sources The cooking appliance of the present disclosure may include a first heat source module 400, a second heat source module 600, and a third heat source module 500. The first heat source module 400, the second heat source module 600 and the third heat source module 500 may be respectively arranged in the cooking appliance of the present disclosure, and may be different types of heat sources. Hereinbelow, these plurality of heat sources, cooling device (cooling fan modules) for cooling the heat sources, and devices for measuring a state of the cooking appliance will be described in priority.

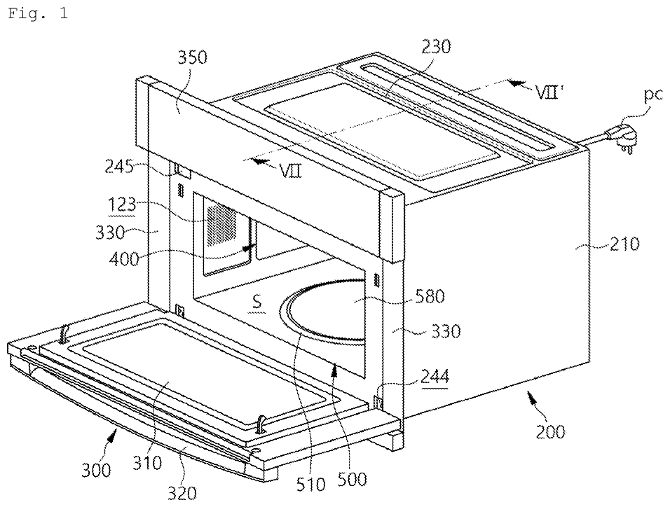

FIG. 1 is the perspective view showing a cooking appliance according to an embodiment of the present disclosure. As shown in the drawing, a cavity S may be provided inside the cooking appliance of the embodiment, and the cavity S may be opened and closed by a door 300. Remaining parts of the cooking appliance except the door 300 may be shielded by a casing 100, 200. The cavity S is a kind of empty portion, and may be referred to as a cooking chamber. The casing 100, 200 may include the inner casing 100 and the outer casing 200. Specific structures of the inner casing 100 and the outer casing 200 will be described below.

In the embodiment shown in FIG. 1, the first heat source module 400 may be arranged at a left portion of the cooking appliance. The second heat source module 600 may be arranged at an upper portion of the cooking appliance. The third heat source module 500 may be arranged at the bottom of the cooking appliance. As described above, in the embodiment, the first heat source module 400, the second heat source module 600, and the third heat source module 500 may be respectively arranged at different surfaces among 6 surfaces constituting the casing 100, 200.

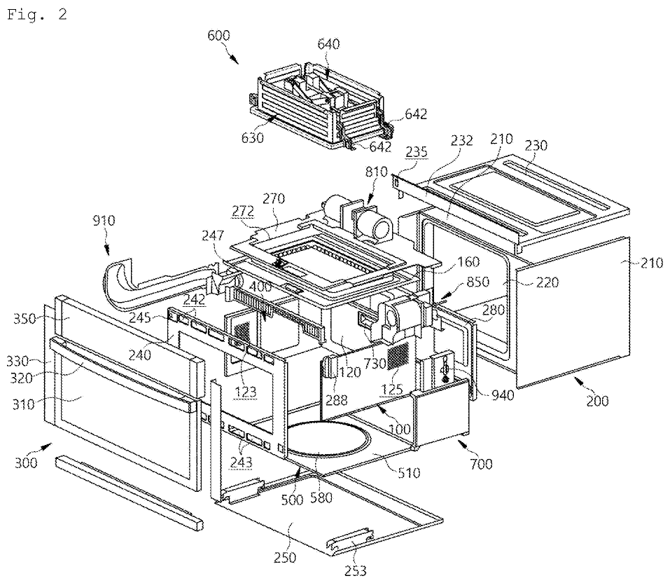

FIG. 2 shows dissembled components constituting the cooking appliance to exposure the second heat source module 600. In the embodiment, the second heat source module 600 may move vertically between the first position and the second position. Referring to the drawing, the second heat source module 600 may move toward the bottom surface of the cavity S, i.e., toward the third heat source module 500 while being raised and lowered.

Otherwise, in another embodiment, the first heat source module 400 may be arranged at a right portion of the cooking appliance, and the second heat source module 600 may be arranged at a rear surface of the cooking appliance. Furthermore, the second heat source module 600 may be fixed to the casing 100, 200 without moving.

As shown in FIG. 2, the inner casing 100 constituting the casing 100, 200 may be provided to surround the cavity S. The inner casing 100 may include a pair of inner side plates 110 and an inner rear plate 120 connecting one inner side plate 110 to the other side plate 110. The pair of inner side plates 110 and the inner rear plate 120 may be arranged into an approximately ‘C’ shape.

The second heat source module 600 may be arranged at an upper portion of the inner casing 100. In other words, it may be said that the second heat source module 600 shields an upper portion of the cavity S. The third heat source module 500 may be arranged at a lower portion of the inner casing 100. It may be said that the third heat source module 500 shields a lower portion of the cavity S. Therefore, it may be said that the third heat source module 500 and the second heat source module 600 are also a part of the inner casing 100 surrounding the cavity S.

An inlet port 123 and an outlet port 125 may be respectively formed on a pair of the inner side plates 110. Since the inlet port 123 and the outlet port 125 are respectively formed on the pair of side plate, it may be said that the inlet port and the outlet port are arranged opposite to each other. The inlet port 123 and the outlet port 125 are open toward the cavity S to connect the cavity S to the outside space.

The inlet port 123 is open toward the cavity S. A supply duct 910 may be arranged on an outer surface of the side plate with the inlet port 123 to allow air to be supplied through the inlet port 123. Water evaporates from food cooked by the first heat source module 400, so that a lot of moisture may be generated inside the cavity S. In order to remove such moisture, it is necessary to supply air into the cavity S. In the embodiment, air may be injected through the inlet port 123, and air may be discharged through the outlet port 125 located opposite to the inlet port 123. At this point, the air supplied through the inlet port 123 may be a part of air acting heat dissipation (cooling) while passing through the inside space of the casing 100, 200.

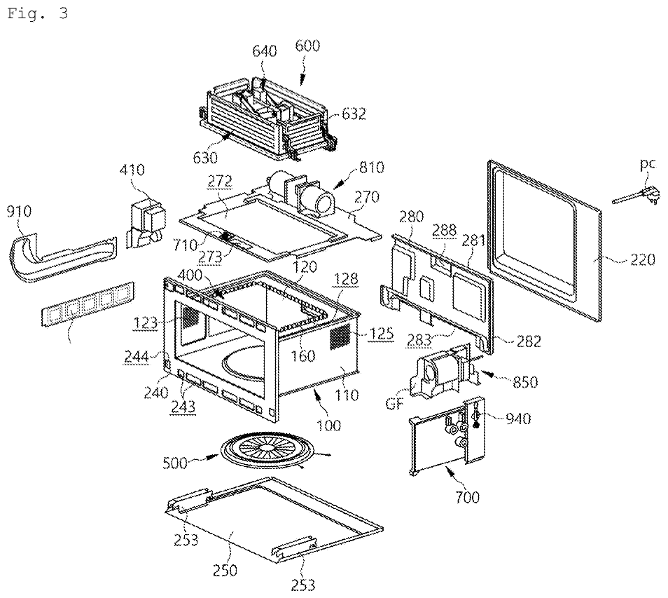

As shown in FIG. 3, the inner rear plate 120 may include a camera mounting part 128. A camera module 730 may be mounted to the camera mounting part 128. The camera mounting part 128 may have a shape recessing rearward from the cavity S, and on the other hand, may have a structure protruding when viewed from the rear side of the inner rear plate 120. Preferably, the camera mounting part 128 may be arranged at a center portion of the inner rear plate 120 so that the camera module 730 faces the center of the cavity S. The camera module 730 may capture the inside space of the cavity S. To this end, the camera module 730 may be directed toward the center of the cavity S.

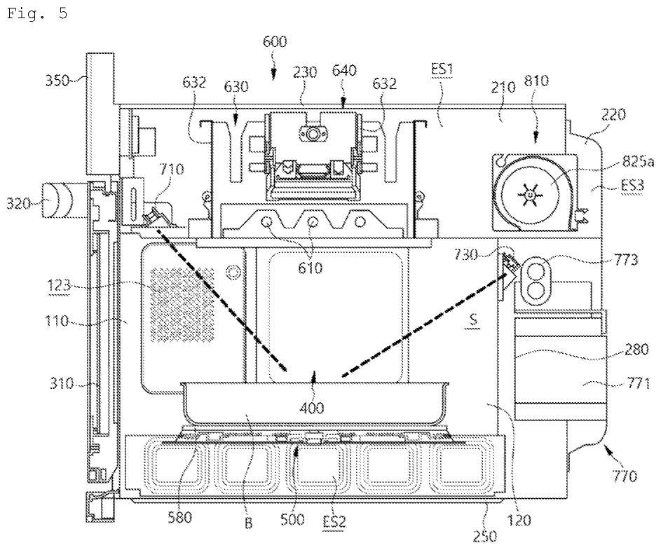

As shown in FIG. 5, the camera module 730 is provided to observe the inside space of the cavity S. The camera module 730 may allow a user to observe cooked food inside the cavity S in real time. Furthermore, a processor 700 may analyze the image captured by the camera module 730 and control appropriate cooking temperature and time.

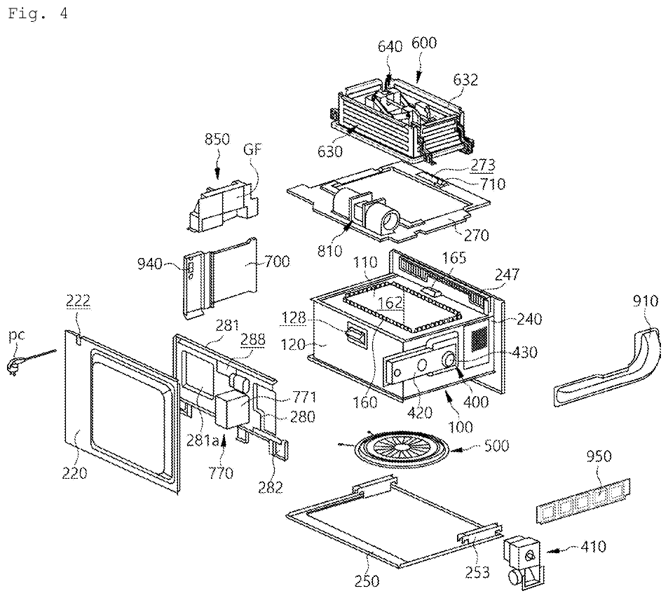

Referring to FIGS. 3 and 4, an inner upper plate 160 may be arranged on the inner rear plate 120. The inner upper plate 160 may have an approximately rectangular frame, and be arranged along an upper edge of the pair of side plates. An upper plate opening 162 may be formed in a center portion of the inner upper plate 160 as a kind of empty portion. The second heat source module 600 may be raised and lowered through the upper plate opening 162.

The inner upper plate 160 may include a lighting part 165. The lighting part 165 may be provided at an upper portion of the inner upper plate 160. In the embodiment, the lighting part 165 may be provided at a middle portion of a front portion of the inner upper plate 160, which is close to the door 300.

In addition, the lighting part 165 may have an inclined shape. Accordingly, the lighting part 165 may have a light emitting angle that is inclined toward the center of the cavity S.

The outer casing 200 may be arranged outside the inner casing 100. The outer casing 200 may enclose the inner casing 100. An electric chamber, i.e., a predetermined space, may be provided between the inner casing 100 and the outer casing 200. The processor 700, a first cooling fan module 810, a second cooling fan module 850, a power supply unit 770, etc., may be arranged in the electric chamber. The second heat source module 600 may also be arranged between the inner casing 100 and the outer casing 200.

As shown in FIG. 2, the outer casing 200 may include a pair of outer side plates 210, an outer rear plate 220 connecting the pair of outer side plates 210 to each other, an outer upper plate 230 arranged at the upper portion, an outer front plate 240 arranged at the front side, and an outer lower plate 250. The outer casing 200 may cover the entire outer surfaces of the inner casing 100, and therefore, the inner casing 100 may be covered by the outer casing 200 from the outside space.

The outer upper plate 230 may have an approximately rectangular plate shape. The outer upper plate 230 may be arranged above the second heat source module 600. The outer upper plate 230 may shield the second heat source module 600. The outer upper plate 230 may be considered as a part arranged at the outermost portion of the upper portion of the cooking appliance.

An upper plate shielding part 232 may be provided at a front portion of the outer upper plate 230. The upper plate shielding part 232 may have formed such that the front portion of the outer upper plate 230 is perpendicularly bent. The upper plate shielding part 232 may support a display substrate (not shown) provided in a display module 350 to be described below, in a rear-to-front direction, and may prevent the inner structure of the cooking appliance from being exposed forward through the display module 350. Reference numeral 235 may indicate a hole through which a part of a wire harness may pass rearward, and may be omitted.

The outer front plate 240 may be arranged at the rear side of the door 300. The outer front plate 240 may have an approximately rectangular frame shape. A center portion of the outer front plate 240 may be empty to expose the inside space of the cavity S to the outside space. The outer front plate 240 may be coupled to front portions of the pair of inner side plates 110 constituting the inner casing 100. Therefore, the outer front plate 240 may be considered as a part of the inner casing 100, not a part of the outer casing 200.

In the embodiment, the height of the outer front plate 240 is higher than the pair of inner side plates 110 constituting the inner casing 100, so that an upper rear portion and a lower rear portion of the outer front plate 240 may have empty portions, respectively. These empty portions may serve as electric chambers in which parts are mounted and may serve as a heat dissipation space to dissipate heat of the parts. For example, the first cooling fan module 810, the second cooling fan module 850, and the second heat source module 600, which will be described below, may be arranged at a rear side of a portion of the outer front plate 240, the portion protruding further upward than the inner side plates 110.

The outer front plate 240 may have an air inlet part 242 and an air outlet part 243. In the embodiment, the air inlet part 242 may be arranged in an upper portion of the outer front plate 240 and the air outlet part 243 may be arranged in a lower portion of the outer front plate 240 The air inlet part 242 and the air outlet part 243 may extend in a transverse direction of the outer front plate 240. Outside air may be introduced into a first electric chamber ES1 through the air inlet part 242 to cool the parts including the heat sources, and air heated by heat of the parts may be discharged to the outside space through the air outlet part 243.

The air inlet part 242 may be formed in the portion of the outer front plate 240, the portion protruding further upward than the pair of inner side plates 110. The first cooling fan module 810 and the second cooling fan module 850 may be arranged at the rear side of the air inlet part 242. Therefore, when the first cooling fan module 810 and the second cooling fan module 850 are operated, outside air may be introduced into the first electric chamber ES1 provided between the outer upper plate 230 and the inner upper plate 160 through the air inlet part 242.

The air outlet 243 may be formed in a portion of the outer front plate 240, the portion protruding further downward than the third heat source module 500. A second electric chamber ES2 provided between the third heat source module 500 and the outer lower plate 250 may be provided behind the air outlet 243. The air introduced into the cooking appliance through the air inlet part 242 may be discharged through the air outlet part 243 after passing through the second electric chamber ES2.

A hinge hole 244 may be provided in a lower portion of the outer front plate 240. The hinge hole 244 may be a portion through which a hinge assembly (not shown) of the door 300 passes. The hinge assembly may be coupled to a hinge holder 253 provided at the outer lower plate 250 through the hinge hole 244.

An upper portion of the outer front plate 240 may include a connector part 245. The connector part 245 may be arranged at the upper portion of the outer front plate 240. The connector part 245 is electrically connected to the processor 700, and an operator can control the processor 700 by coming into contact with the connector part 245. The connector part 245 may be omitted, or may be arranged at the outer rear plate 220 or the outer side plates 210.

A shield frame 247 may be provided behind the outer front plate 240. The shield frame 247 may be arranged behind the air inlet part 242 of the outer front plate 240, and block access to wire harness from the outside space, and shield inner parts of the cooking appliance. The shield frame 247 has a plurality of slits, allowing the air introduced through the air inlet part 242 to pass therethrough.

The outer casing 200 may include the outer lower plate 250. The outer lower plate 250 may be arranged below the inner casing 100. In the embodiment, the outer lower plate 250 may connect the outer rear plate 220 to the outer front plate 240. Furthermore, the outer lower plate 250 may be connected to an insulation rear plate 280 to be described below. The outer lower plate 250 may be spaced apart from the third heat source module 500, and the gap therebetween may serve as the second electric chamber ES2.

Meanwhile, in defining the electric chamber described above, the electric chamber may be divided into a plurality of spaces. In the embodiment, the electric chamber may be divided into the first electric chamber ES1 to a fifth electric chamber ES5, (i) the first electric chamber ES1 is provided between the inner upper plate 160 and the outer upper plate 230, (ii) the second electric chamber ES2 is provided between the third heat source module 500 and the outer lower plate 250, (iii) the third electric chamber ES3 is provided between the insulation rear plate 280 and the outer rear plate 220, and (iv) the fourth electric chamber ES4 and the fifth electric chamber ES5 may be respectively provided between the pair of inner side plates 110 and the pair of outer side plates 210. The first electric chamber ES1 and the fifth electric chamber ES5 may be arbitrarily classified, and be connected to each other.

At this point, each electric chamber may be provided at each surface of the casing. The first electric chamber to the fifth electric chamber ES1 to ES5 may be provided at different surfaces of the casing of a hexahedron. In addition, the first heat source module 400, the third heat source module 500, and the second heat source module 600 may be arranged at different surfaces of the casing.

The outer casing 200 may include an insulation upper plate 270. The insulation upper plate 270 may be arranged between the outer upper plate 230 and the inner upper plate 160. Since the cavity S generates high temperature heat during a cooking process, the temperature of the inner upper plate 160 may also increase. The insulation upper plate 270 may reduce heat transferred from the inner upper plate 160 to the outer upper plate 230. The insulation upper plate 270 may have a rectangular frame shape with a hollow center portion same as the inner upper plate 160. A movable opening 272 formed in the center portion of the insulation upper plate 270 may be connected to the upper plate opening 162 of the inner upper plate 160, and the second heat source module 600 may move through the movable opening 272 and the upper plate opening 162.

As shown in FIGS. 3 and 4, a distance sensor 710 and the cooling fan module 810, 850 may be arranged at the insulation upper plate 270. Since the distance sensor 710 and the cooling fan module 810, 850 are arranged at the insulation upper plate 270, it is possible to prevent heat of the cavity S from being directly transferred to the distance sensor 710 and the cooling fan module 810, 850. Therefore, the durability of the cooling fan module 810, 850 may be improved.

The distance sensor 710 may measure the existence or nonexistence of cooked food, thickness of cooked food, or height of cooked food. The distance sensor 710 may measure the thickness or height of cooked food. According to the measured information, the processor 700 may control the first heat source module 400, the third heat source module 500, or the second heat source module 600 with different operations and temperatures. Furthermore, the distance sensor 710 may measure the thickness or height of cooked food, which are changed according to a cooking time, and the processor 700 may control a remaining cooking time or cooking temperature. The distance sensor 710 may be an infrared sensor.

Furthermore, it is preferable that the distance sensor 710 is arranged at a center portion based on a transverse width of the insulation upper plate 270, so that the distance sensor 710 faces the center portion of the cavity S. The inner upper plate 160 is arranged below the insulation upper plate 270, and the inner upper plate 160 has an opening sensing hole (not shown) to allow the distance sensor 710 to sense the inside space of the cavity S through the sensing hole. As described above, in the embodiment, since the distance sensor 710 is arranged at the insulation upper plate 270, it is possible to prevent heat of the cavity S from being directly transferred to the distance sensor 710. Therefore, the durability of the distance sensor 710 can be improved.

A protection cover 276, which blocks electromagnetic waves introduced through a gap between a moving assembly 630 and a fixed assembly 640 to be described below, may be provided at the insulation upper plate 270. The protection cover 276 may have a shape of surrounding an edge of a fan through portion 278a, 278b formed in a center portion of the insulation upper plate 270. The protection cover 276 will be described below again.

The insulation upper plate 270 may have the fan through portion 278a, 278b. The fan through portion 278a, 278b may be formed at a portion of the insulation upper plate 270, which protrudes further rearward than the inner casing 100. Therefore, the fan through portion 278a, 278b may be open outwards of the inner casing 100. In the embodiment, the fan through portion 278a, 278b may be open toward the rear side of the insulation rear plate 280 coupled to the inner casing 100.

The first cooling fan module 810 may be arranged in one portion of the fan through portion 278a, 278b. The power supply unit 770 may be arranged below the fan through portion 278a, 278b. Therefore, air discharged from the first cooling fan module 810 may be discharged downward, i.e., toward the power supply unit 770 through the fan through portion 278a, 278b.

The power supply unit 770 may receive external power and deliver it to the inner parts of the cooking appliance. The power supply unit 770 may include a high voltage transformer 771, a high voltage capacitor 773, and a fuse. The parts constituting the power supply unit 770 are only examples, and additional parts may be provided or some of the parts may be omitted.

The high voltage transformer 771 may serve to apply high pressure current to a magnetron 410. For example, the high voltage transformer 771 may be a part provided to boost the household voltage, which is usually 100 to 220V, to a high voltage. Furthermore, the high voltage transformer 771 may supply power to a working coil 570 of the third heat source module 500 or a heating unit 610 of the second heat source module 600. In the drawings, a busbar or a wire harness, which is provided to the high voltage transformer 771, the magnetron 410, etc. may be omitted.

In the embodiment, the power supply unit 770 may be arranged on a surface 281 of the insulation rear plate 280. The insulation rear plate 280 may be coupled to the inner rear plate 120, and prevent heat of the inner rear plate 120 from being directly transferred to the power supply unit 770. The insulation rear plate 280 may have an approximately rectangular plate shape, and a camera avoidance hole 288 is formed in the insulation rear plate 280 to avoid interference with the camera module 730.

The high voltage transformer 771 and the high voltage capacitor 773 may be mounted to a rear surface 281a of the insulation rear plate 280. In the embodiment, the high voltage transformer 771 may be arranged at a right portion based on the center of the insulation rear plate 280. More precisely, the high voltage transformer 771 may be arranged at a lower portion of the second cooling fan module 850.

As shown in FIG. 2, the insulation rear plate 280 may be arranged between the inner rear plate 120 and the outer rear plate 220. The insulation rear plate 280 is coupled to the inner rear plate 120, and the third electric chamber ES3 may be provided between the insulation rear plate 280 and the outer rear plate 220. The insulation rear plate 280 may reduce heat transferred from the inner rear plate 120 to the outer rear plate 220, like the insulation upper plate 270.

As shown in FIGS. 3 and 4, the insulation rear plate 280 may have a rectangular plate shape. One surface of the insulation rear plate 280 may face the inner rear plate 120, and the opposite surface may face the outer rear plate 220. The insulation rear plate 280 may be coupled to the inner rear plate 120, and the power supply unit 770 may be arranged on the surface of the insulation rear plate 280, which faces the outer rear plate 220. Therefore, the insulation rear plate 280 may prevent heat of the inner upper plate 160 from being directly transferred to the power supply unit 770.

A spacer 282 may be arranged at a lower portion of the insulation rear plate 280. The spacer 282 may further protrude downward from the insulation rear plate 280. The spacer 282 may allow a lower end of the insulation rear plate 280 to be spaced apart from the outer lower plate 250. Air may flow into an empty portion defined by the spacer 282 between the lower end of the insulation rear plate 280 and the outer lower plate 250. Reference numeral 283 indicates a ventilation part through which air flows. The spacer 282 may be integrally formed with the insulation rear plate 280 or be a separate object assembled to the insulation rear plate 280.

As shown in FIGS. 1 and 2, the door 300 may be provided at front of the outer front plate 240. The door 300 may serve to open and close the cavity S. The door 300 may be swung by coupling the hinge assembly provided at a lower portion of the door to the hinge holder 253 provided at the outer lower plate 250. A penetration part 310 of the door 300 may be made of a transparent or translucent material, so that a user can observe the cavity S from the outside space. Reference numeral 320 indicates a handle of the door 300.

Left and right frames 330 may be coupled to side surfaces of the door 300, and a lower frame 340 may be coupled to a lower end of the door 300. Although not shown in the drawings, an upper frame may be provided at an upper portion of the door 300. The frames may surround the penetration part 310 to form the frame of the door 300.

In addition, the display module 350 may be arranged at an upper portion of the door 300. The display module 350 may display a cooking state of the cooking appliance, and include an interface for the user to operate the cooking appliance. The air inlet part 242 is arranged below the display module 350, thereby preventing the display module 350 from interfering with the air inlet part 242.

The display module 350 may include an input part 351 and a display part 352. The input part 351 may provide an interface from which the user inputs an operation command for operating the cooking appliance. The display part 352 may inform the user of a variety of information such as an operation state of the cooking appliance, a cooked state of cooked food, etc. by displaying it. The input part 351 may include a touch type input means. The touch type input means may include a touch sensor detecting a touch movement as a device that inputs an operation command by a touch of the user. For example, the touch type input means may be implemented as the input part 351 and the display part 352 that are formed into an integrated body, or into the display module 350 as one module. When the display part 352 and the touch sensor are arranged while being mutually layered to form a touch screen, the display module 350 may be implemented into an input part 910. The touch sensor may have a form of, for example, a touch film, a touch sheet, a touch pad, etc. The user can input an operation command of the first, second, third heat source module 400, 600, 500 through the input part 351. Furthermore, the user can input a raising or lowering command of the second heat source module 600 through the input part 351.

The first heat source module 400 may be arranged at the inner casing 100. The first heat source module 400 may generate microwaves to cook cooked food. In the embodiment, the first heat source module 400 may be arranged at the inner side plates 110 of the inner casing 100. Referring to FIG. 2, the first heat source module 400 may be arranged outside the inner side plate 110 arranged at the left side among the pair of inner side plates 110.

Since the magnetron 410 of the first heat source module 400 is arranged adjacent to the insulation rear plate 280, it may be said that the first heat source module 400 is arranged in the fourth electric chamber ES4 and the fifth electric chamber ES5. In other words, it may be said that the first heat source module 400 may be arranged along two surfaces of the casing 100, 200. Otherwise, the magnetron 410 may be arranged at the inner side plates 110 together with a wave guide 420. Otherwise, the first heat source module 400 may be arranged outside the inner side plate 110 arranged at the right side among the pair of inner side plates 110, or may be arranged outside the pair of inner rear plates 120.

Referring to FIGS. 3 and 4, the first heat source module 400 may include the magnetron 410 oscillating microwaves, and the wave guide 420 guides the microwaves oscillated from the magnetron 410 to the cavity S. The magnetron 410 may be mounted to a portion where the wave guide 420 protrudes from the inner side plate 110. The microwaves generated by the magnetron 410 may be transferred to the cavity S through the wave guide 420.

Since the magnetron 410 is mounted to the portion protruding from the inner side plates 110, the magnetron 410 may be arranged in the third electric chamber ES3. As described above, when the magnetron 410 is arranged in the third electric chamber ES3, the magnetron 410 may be cooled by the first cooling fan module 810.

Next, the third heat source module 500 will be described. The third heat source module 500 may be arranged at a bottom surface of the casing 100, 200. The third heat source module 500 may heat cooked food rapidly by an induction heating method. The third heat source module 500 may be fixed to on the bottom surface of the casing 100, 200. As shown in FIGS. 2 and 3, in the embodiment, it is said that the third heat source module 500 constitutes the bottom of the inner casing 100. In other words, the cavity S may be exposed through the upper portion of the third heat source module 500.

The third heat source module 500 may be controlled by the processor 700. The processor 700 may control the third heat source module 500 in an inverter method, and control power of the third heat source module 500 linearly. Therefore, detailed control of the third heat source module 500 may be realized.

A bowl B may be arranged on an upper portion of the third heat source module 500 to place cooked food thereon. A bottom portion of the bowl B may be made of a metal material having magnetism such as a stainless steel sheet. When the bowl B is heated by magnetic field└ generated by the working coil 570, cooked food put in the bowl B may also be heated together.

As shown in FIG. 1, a cover plate 580 on which the bowl B is seated may be provided at a center portion of the third heat source module 500. The cover plate 580 may be arranged at a position facing the heating unit 610 constituting the second heat source module 600. Therefore, a lower portion of cooked food may be heated by the third heat source module 500 and an upper portion thereof may be heated by the second heat source module 600.

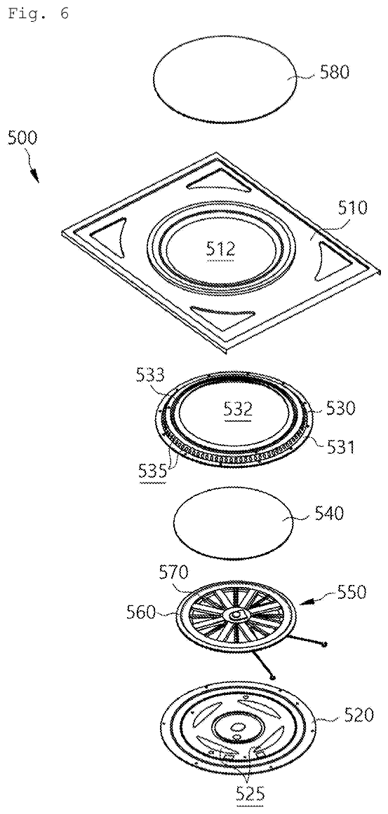

FIG. 6 shows a disassembled structure of the third heat source module 500. As shown in the drawing, the third heat source module 500 may include a base plate 510 and a supporter 520. Furthermore, a mounting bracket 530, a shield filter 540, and a coil assembly 550 may be arranged between the base plate 510 and the supporter 520.

The base plate 510 has an approximately rectangular plate shape having an empty base hole 512 in a center portion thereof. The base plate 510 may be seen as a lower plate of the inner casing 100 constituting the bottom surface of the cavity S. The cover plate 580 may be arranged at the base hole 512, and the cover plate 580 may be composed of a non-magnetic substance. The base plate 510 may be made of a metal material of a magnetic substance. The base plate 510 composed of a magnetic substance may prevent the microwaves generated by the first heat source module 400 from reaching the working coil 570.

The supporter 520 may have an approximately circular plate shape, and the supporter 520 may have a plurality of heat dissipation slits 525 for heat dissipation. In addition, an upper surface of the supporter 520 may include a coil base 560 and the working coil 570 constituting the coil assembly 550. The supporter 520 may serve to shield electromagnetic interference (EMI).

The mounting bracket 530 may be arranged between the base plate 510 and the supporter 520. The mounting bracket 530 is coupled to both of the base plate 510 and the supporter 520 to connect the base plate 510 to the supporter 520. In the embodiment, the base plate 510 is coupled to the mounting bracket 530 by welding, and the mounting bracket 530 and the supporter 520 are coupled to each other by screwing. Otherwise, the base plate 510 and the supporter 520 may also be coupled to each other by screwing, and the mounting bracket 530 and the supporter 520 may be coupled to each other by welding.

At this point, the supporter 520 and the coil base 560 may be coupled to each other by screwing. Eventually, the coil assembly 550 may be fixed not only to the supporter 520 but also to the base plate 510 through the mounting bracket 530 as a medium. Therefore, both upper and lower portions of the coil assembly 550 may be securely fixed.

The base plate 510 may have a plurality of uneven structures. The uneven structures are provided to be coupled to the mounting bracket 530, the shield filter 540, and the coil base 560. In the embodiment, the shield filter 540 is arranged between the uneven structures the base plate 510 and the coil base 560. The shield filter 540 may be securely fixed between the uneven structures and the coil base 560.

A first cover 513 may be provided at a position adjacent to an edge of the base hole 512. The first cover 513 may cover a part of an edge of the shield filter 540. The edge of the shield filter 540 may be pressed. Therefore, electromagnetic waves generated by the first heat source module 400 may be prevented from leaking toward the working coil 570 through a gap between the shield filter 540 and the coil base 560.

The base plate 510 and the coil base 560 may be aligned in an X-axis and a Y-axis, and electromagnetic waves generated by the first heat source module 400 may be prevented from leaking through a gap between the base plate 510 and the coil base 560.

Furthermore, an edge portion of the shield filter 540 may be pressed. The shield filter 540 may be fixed in the X axial direction and the Y axial direction, respectively. Therefore, even when a fastening tool such as a screw is not used, the shield filter 540 may be securely fixed.

The mounting bracket 530 may connect the base plate 510 to the supporter 520. The mounting bracket 530 has an approximately circular frame shape, and a bracket through portion 532 may be formed in a center portion of the mounting bracket 530. As shown in FIG. 6, the mounting bracket 530 may include a bracket lower portion 531 having a relatively wider diameter, and a bracket upper portion 534 having a relatively narrower diameter. In addition, the bracket lower portion 531 and the upper and the bracket upper portion 534 may be connected to each other by a bracket connection portion 533.

At this point, since the mounting bracket 530 is arranged between the base plate 510 and the supporter 520, the base plate 510 and the supporter 520 may be spaced apart from each other by at least the height of the mounting bracket 530. The coil assembly 550 may be arranged in the spacing between the base plate 510 and the supporter 520. The height of the bracket connection portion 533 may be the height of the mounting bracket 530.

The bracket connection portion 533 may have a bracket heat dissipation hole 535 for heat dissipation. The bracket heat dissipation hole 535 may be open sideways. The bracket heat dissipation hole 535 may dissipate heat between the supporter 520 and the base plate 510 and, inversely, outside air may be introduced into the bracket heat dissipation hole 535 to cool the coil assembly 550.

The shield filter 540 may be arranged between the cover plate 580 and the coil assembly 550. The shield filter 540 may have an approximately circular plate structure, and may cover the upper portion of the working coil 570. The shield filter 540 may prevent electromagnetic waves generated by the first heat source module 400 from being transferred to the working coil 570. The shield filter 540 may be composed of one selected from among graphite, graphene, carbon fabric, carbon paper, and carbon felt.

As described above, when the shield filter 540 is composed of one selected from among graphite, graphene, carbon fabric, carbon paper, and carbon felt, the shield filter 540 may have excellent microwave shield performance due to high conductivity. Furthermore, since the shield filter 540 may maintain heating by the third heat source module 500, heating performance of the third heat source module 500 can be maximized. Furthermore, when the shield filter 540 is composed of one selected from among graphite, graphene, carbon fabric, carbon paper, and carbon felt, it is easy to emit heat heated by microwaves due to high thermal conductivity.

In the embodiment, the shield filter 540 may be formed of graphite sheet and mica sheet (mica) that are laminated together. At this point, the mica sheet may be relatively thicker than the graphite sheet. For example, when the thickness of the graphite sheet is 0.2 mm, the thickness of the mica sheet may be 1.0 mm.

The diameter of the shield filter 540 is larger than the working coil 570, and be smaller than the diameter of the cover plate 580 and the diameter of the supporter 520. Accordingly, the shield filter 540 may completely cover an upper portion of the working coil 570 to prevent microwaves transferred to the working coil 570. On the other hand, the shield filter 540 may efficiently transfer the magnetic field└ generated by the working coil 570 upwards through the cover plate 580.

The shield filter 540 may be fixed to the third heat source module 500 without a separate fastening tool. When a fastening tool is used, the microwaves may be introduced toward the working coil 570 through a hole for fastening the fastening tool, or a through screw thread to affect the working coil 570. Furthermore, an electric field is concentrated to an edge of a hole or a sharp screw thread so that arc discharge may occur and there is a risk of fire. Therefore, a structure, which is provided to fix the shield filter 540 without a fastening tool is applied to the embodiment.

The coil base 560 of the coil assembly 550 may have an approximately circular shape and the working coil 570 may be wound on the coil base 560. A temperature sensor (not shown) may be arranged at a center portion of the coil assembly 550. The temperature sensor may measure the temperature of the third heat source module 500. Based on the temperature of the third heat source module 500 measured by the temperature sensor, the user can control the temperature of the third heat source module 500. Although not shown in the drawings, in order to increase the density of the magnetic fields generated by the working coil 570, the coil assembly 550 may include ferrite, which is a magnetic ceramic material having oxidized steel (Fe2O3) as main component.

The cover plate 580 may be arranged in the base hole 512 of the base plate 510. The cover plate 580 may have an approximately circular plate shape. The cover plate 580 may cover the base hole 512, and may form an upper surface of the third heat source module 500 into a flat surface structure. The cover plate 580 may be made of a non-metallic substance so that the magnetic fields of the working coil 570 may pass through the cover plate 580. The cover plate 580 may be made of a glass material having heat resistance against heat or the like (for example, ceramics glass). The cover plate 580 may distribute heat of the shield filter 540.

In a process of assembling the third heat source module 500, while the base plate 510 is turned over, the mounting bracket 530 may be coupled to the base plate 510. The mounting bracket 530 may be arranged around the base hole 512. The mounting bracket 530 is seated on the base plate 510 and the mounting bracket 530 and the base plate 510 may be coupled to each other by welding, etc.

In this state, the shield filter 540 may be coupled to cover the base hole 512 of the base plate 510. The shield filter 540 is only seated on the base plate 510, and a fastening process by welding or a fastening tool is not performed.

Next, the coil assembly 550 and the supporter 520 may be laminated on the shield filter 540. Since the coil base 560 of the coil assembly 550 is larger than the shield filter 540, the shield filter 540 may be completely blocked.

In this state, the supporter 520 is seated on the coil assembly 550, and the supporter 520 and the coil base 560 may be coupled to each other by a fastening tool such as a screw. Furthermore, the supporter 520 and the mounting bracket 530 may be also coupled to each other by a fastening tool such as a screw. At this point, since the mounting bracket 530 has been coupled to the base plate 510 in advance, the supporter 520 and the coil assembly 550 may be coupled to the base plate 510 with the mounting bracket 530 as a medium.

In this process, the shield filter 540 may be pressed between the base plate 510 and the coil base 560. In other words, the shield filter 540 may be securely fixed by being pressed even without a separate fastening tool.

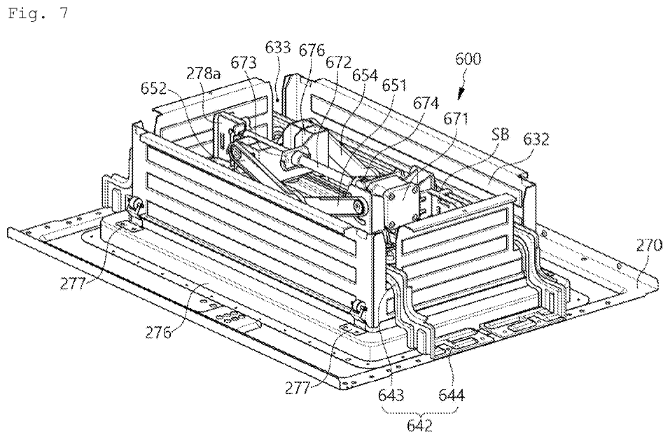

Next, the second heat source module 600 will be described with reference to FIGS. 7 to 11. The second heat source module 600 may be arranged at an upper portion of the casing 100, 200. The second heat source module 600 may generate radiant heat toward the cavity S. To this end, the second heat source module 600 may include the heating unit 610. The heating unit 610 may include a plurality of heating units. The plurality of heating units 610 may generate radiant heat toward the lower side, i.e., toward the cavity S, and heat the upper portion of cooked food. Each heating unit 610 may be a graphite heater. This each heating unit serves as a kind of broil heater, and the heating unit may be used as a grill using direct fire heat or radiant heat.

The second heat source module 600 may be fixed to the inner casing 100 or the outer casing 200. In the embodiment, the second heat source module 600 may be fixed to the insulation upper plate 270. It may be said that the second heat source module 600 is arranged in the first electric chamber ES1. In addition, the outer upper plate 230 is arranged above the second heat source module 600, and the second heat source module 600 may be shielded. As shown in FIG. 1, the view shows the second heat source module 600 shielded by the outer upper plate 230.

The second heat source module 600 may move toward the bottom of the cavity S, i.e., toward the third heat source module 500. The second heat source module 600 includes the moving assembly 630 to move the plurality of heating units 610. In the embodiment, since the plurality of heating units 610 moves vertically, it may be presented that the plurality of heating units 610 is raised and lowered.

The second heat source module 600 may include the moving assembly 630 to which the plurality of heating units 610 is mounted, and protecting the plurality of heating units 610, and the fixed assembly 640 provided at the insulation upper plate 270 to control vertical movement of the moving assembly 630. In addition, the second heat source module 600 may further include the link assembly 650, which is provided at one portion of the moving assembly 630 to allow the moving assembly 630 to be movably connected to the fixed assembly 640. Hereinbelow, the structure will be described.

The moving assembly 630 may be provided separately from the inner casing 100 and the outer casing 200 to be vertically moving inside the cavity S. The moving assembly 630 may be provided to surround at least side portion of each heating unit 610, and heat of each heating unit 610 is preferably concentrated downward without being emitted sideways.

The moving assembly 630 may have multiple levels of height. For example, the moving assembly 630 may have a first level at the highest location, a second level at a middle location, and a third level at a lowest location. When the moving assembly 630 is at the third level height, heat of each heating unit 610 transferred to cooked food may be strongest. The processor 700 may adjust the height of the moving assembly 630 for each level.

The moving assembly 630 may include a heater housing 632 surrounding and protecting the plurality of heating units 610, and an insulating member 635 provided at one end of the heater housing 632 and blocking heat or electromagnetic waves. The heater housing 632 may have a rectangular box as shown in the drawings. A bottom surface of the heater housing 632 may have at least one vertical through hole, through which heat of each heating unit 610 may pass.

The heater housing 632 may pass through a gap between a fixed frame 641 to be described below and the protection cover 276 to move vertically. Therefore, the heater housing 632 may have a rectangular box shape having an open upper portion, and have a predetermined thickness. The thickness of each of four lateral surfaces of the heater housing 632 is preferably formed smaller than a size of a gap between the fixed frame 641 and the protection cover 276.

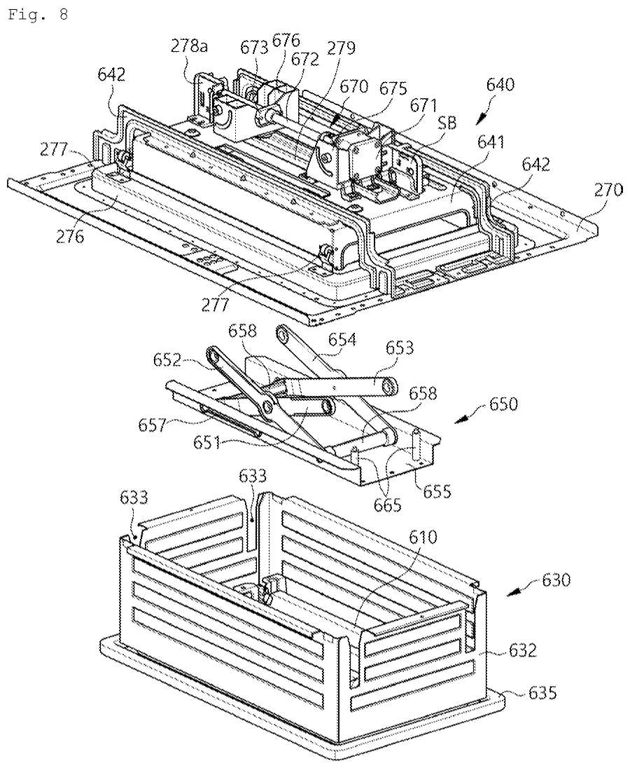

The heater housing 632 may have a guide groove 633 selectively storing a fixed guide 642 to be described below. In other words, as shown in FIG. 8, the guide groove 633 is formed in each of left and right surfaces of the heater housing 632 by being depressed from the upper end thereof by a predetermined depth. When the moving assembly 630 is raised, a frame coupling portion 643 of the fixed guide 642 is stored in this guide groove 633.

The insulating member 635 may have a rectangular frame shape as shown in the drawings. Preferably, lateral ends of the insulating member 635 may be formed to further protrude outward than the lateral ends of the heater housing 632. In other words, the exterior size of the insulating member 635 is formed larger than the lateral size of the heater housing 632, thereby preventing electromagnetic waves from leaking outward through the gap between the fixed frame 641 and the protection cover 276 when the moving assembly 630 is raised.

The plurality of heating units 610 may be stored and fixed inside the heater housing 632. The plurality of heating units 610 may have a transversally or longitudinally long shape, and preferably, the plurality of heating units 610 may be provided and installed in an inner lower end of the heater housing 632. As shown in FIG. 5, the view shows total three heating units 610 arranged in the moving assembly 630.

The three heating units 610 are operated independently. In other words, among the three heating units 610, any one or two heating units may be operated, or the three heating units 610 may be operated at the same time. The main controller 700 may control the number of operated heating units among the three heating units 610, or control operating time of the three heating units 610, or control the height of the moving assembly 630 and the height of the heating units 610.

Next, the fixed assembly 640 will be described, the fixed assembly 640 may be securely installed at an upper portion of the insulation upper plate 270. The fixed assembly 640 may support the moving assembly 630 so that the moving assembly 630 may move in the upward and downward directions while being supported by an upper surface of the insulation upper plate 270. The fixed assembly 640 may include a moving control means 670 to restrict the moving assembly 630 to move in the upward and downward directions by operation of the link assembly 650.

The link assembly 650 may be provided at an upper portion of the moving assembly 630. The link assembly 650 may include at least one link, and guide the moving assembly 630 so that the moving assembly 630 moves in the upward and downward directions while being connected to the fixed assembly 640. At this point, upper and lower ends of the link assembly 650 may be rotatably connected to the fixed assembly 640 and the moving assembly 630, respectively.

The insulation upper plate 270 may be regarded as a part of the fixed assembly 640. In addition, the fixed assembly 640 may include the fixed frame 641 that is provided on the insulation upper plate 270 to support the moving control means 670.

At this point, the fixed frame 641 may be provided to be spaced apart of the protection cover 276 of the insulation upper plate 270. More specifically, the entire protection cover 276 may also have a rectangular shape like the insulation upper plate 270, and the protection cover 276 may have a rectangular frame shape with a vertical through hole at a center portion thereof like the insulation upper plate 270. Accordingly, the moving assembly 630 may move in the upward and downward directions through the center hole of the insulation upper plate 270 and the central hole of the protection cover 276.

In addition, the fixed frame 641 may have a rectangular shape smaller than the rectangular-shaped central hole of the protection cover 276. Therefore, a predetermined gap may be provided between the fixed frame 641 and the protection cover 276, and the heater housing 632 of the moving assembly 630, which will be described below, may move in the upward and downward directions through the gap.

The fixed frame 641 may be securely provided on the insulation upper plate 270. To this end, the fixed guide 642 may be provided between the insulation upper plate 270 and the fixed frame 641. The fixed guide 642 may have an approximately ‘n’ shape (view from the front) as shown in the drawings. Therefore, an upper end of the fixed guide 642 may be coupled to the fixed frame 641, and a lower end of the fixed guide 642 may be fixed to the insulation upper plate 270 or the protection cover 276.

Specifically, as shown in FIG. 7, the fixed guide 642 may include the frame coupling portion 643 coupled to the fixed frame 641, an upper coupling portion 644 fixed to the insulation upper plate 270 or the protection cover 276, etc. In the present disclosure, it is proposed as an example that the upper coupling portion 644, i.e., the lower end of the fixed guide 642, is coupled to the upper surface of the insulation upper plate 270.

The fixed assembly 640 may include a sliding rail 279, which slidably supports a moving bracket 676, a lead nut 673, or the like, which will be described below. The sliding rail 279 may be provided with a transversally predetermined length on an upper surface of the fixed frame 641. The moving bracket 676 or the lead nut 673, which will be described below, may be transversally movably installed on this sliding rail 279.

The moving control means 670 may be provided on the fixed frame 641. The moving control means 670 may include a motor 671 generating rotation power, a lead screw 672 provided at one portion of the motor 671 and rotated in conjunction with the rotation generated from the motor 671, and the lead nut 673 fastened to the lead screw 672 by screwing.

The motor 671 may generate rotation power and a stepping motor may be used as the motor 671 so as to perform precise rotation control. The stepping motor may supply forward and reverse rotation movements in response to a rotation angle by purse control.

As shown in the drawings, the lead screw 672 may be a fine cylinder of a predetermined length with an outer surface formed in a male screw. The male screw of the lead screw 672 is coupled to the lead nut 673 having a female screw corresponding to the male screw Therefore, when the lead screw 672 is rotated by power of the motor 671, the lead nut 673 moves transversally along the lead screw 672. As described above, the lead screw 672 and the lead nut 673 may serve to change the forward and reverse rotation movements into a linear movement.

A connection coupling 674 may be provided between the motor 671 and the lead screw 672 to connect one end of the lead screw 672 to a motor shaft. In other words, as shown in FIG. 7, the connection coupling 674 may be provided between a right end of the lead screw 672 and the motor shaft protruding from a left portion of the motor 671.

The motor 671 may be provided to a fixed bracket 675 securely mounted to the fixed assembly 640, and the lead nut 673 may be mounted to the moving bracket 676 movably installed to the fixed assembly 640. The moving bracket 676 may be movably provided to move closer to or farther from the fixed bracket 675 above the fixed frame 641.

Specifically, the fixed frame 641 may be provided above the insulation upper plate 270 to be spaced apart therefrom by the fixed guide 642, and a gap of predetermined size is formed between the fixed frame 641 and the protection cover 276 to serve as a moving path of the heater housing 632, which will be described below.

When the lead screw 672 is rotated in response to rotation of the motor 671 mounted to the fixed bracket 675, the lead nut 673 moves transversally, whereby the moving bracket 676 moves transversally along the sliding rail 279.

Upper ends of a link of the link assembly 650 may be rotatably installed to the fixed bracket 675 and the moving bracket 676. In other words, when left and right upper ends of an ‘X’-shaped link provided in the link assembly 650 are respectively connected to the fixed bracket 675 and the moving bracket 676, the left and right upper ends of the ‘X’-shaped link may move closer to each other or farther from each other in response to leftward and rightward movements of the moving bracket 676, so that the moving assembly 630 fixed to the lower end of the link assembly 650 may move in upward and downward directions.

Meanwhile, the link assembly 650 may have a structure including at least one link, and the upper end of the link assembly 650 may be rotatably connected to the fixed assembly 640 and the lower end thereof may be rotatably connected to the moving assembly 630

The link assembly 650 may include a pair of front links 651 and 652 and a pair of rear links 653 and 654 that are located to be spaced apart from each other by a predetermined distance in a longitudinal direction. A link frame 655 coupled to the moving assembly 630 may be provided at lower ends of the pair of front links 651 and 652 and the pair of rear links 653 and 654.

In addition, preferably, at least one of the left and right lower ends of the front links 651 and at least one of the left and right lower ends of 652 and the rear links 653 and 654 may be movably provided while being coupled to the link frame 655. Specifically, the pair of front links 651 and 652 may be configured such that a front first link 651 and a front second link 652 that are arranged in a ‘X’-shape may be coupled to each other to be rotatable on a center on which the front first link 651 and the front second link 652 cross each other, as a rotation center. Furthermore, the pair of rear links 653 and 654 may be configured such that a rear first link 653 and a rear second link 654 that are arranged in a ‘X’-shape may be coupled to each other to be rotatable on a center on which the rear first link 653 and the rear second link 654 cross each other, as a rotation center.

The lower ends of the front first link 651 and the rear first link 653, which are installed to be spaced apart from each other by a predetermined distance in the longitudinal direction, may be connected to each other by a connection link 658. The lower ends of the front second link 652 and the rear second link 654 may be connected to each other by a connection link 658.

At least one of the left and right lower ends of the front links 651 and 652 and at least one of the left and right lower ends of the rear links 653 and 654 may be preferably provided to be movable while being coupled to the link frame 655. In the embodiment, as shown in the drawing, the view shows a case in which the lower ends of the front first link 651 and the rear first link 653 are installed to be movable in a transverse direction of the link frame 655.

Therefore, first link protrusion holes 657 may be formed in a left half portion of the link frame 655, and lower end shafts of the front first link 651 and the rear first link 653 are inserted thereinto and guided to be movable transversely by the first link protrusion holes.

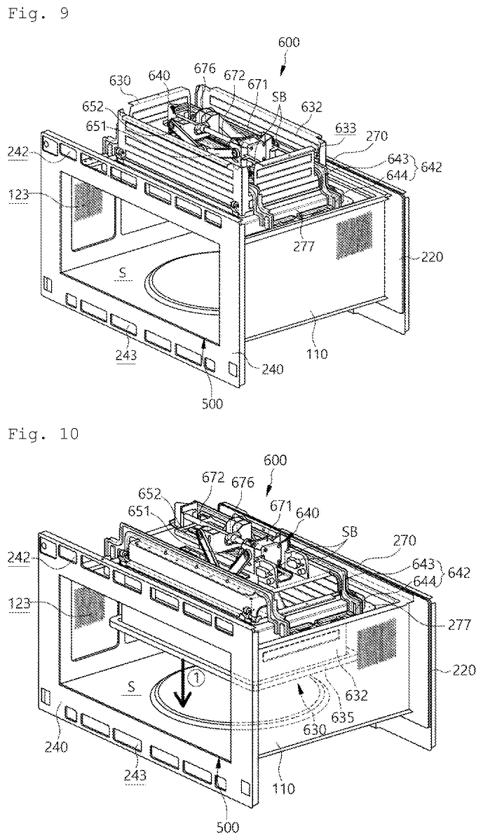

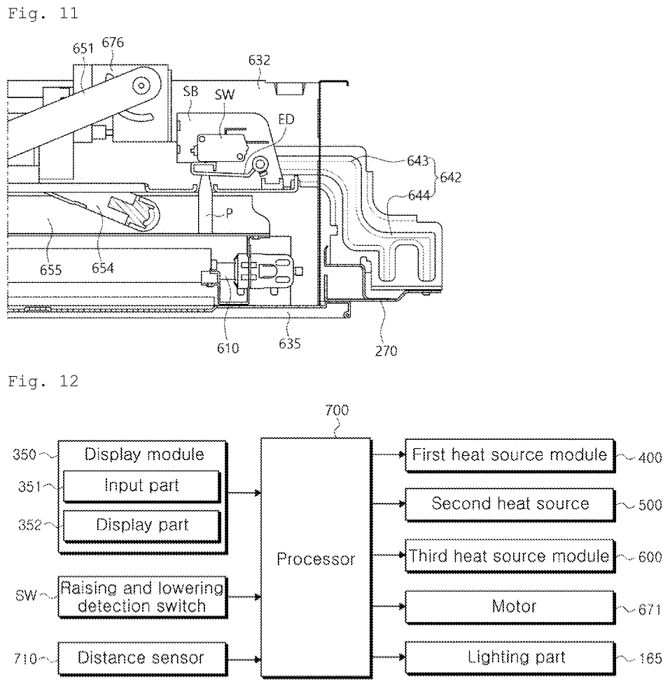

FIG. 9 is a view showing the moving assembly 630 located in the first position, i.e., the initial position. FIG. 10 is a view showing the moving assembly 630 is located in the second position by being lowered from the first position. When the moving assembly 630 is located in the second position, the plurality of heating units 610 is located close to cooked food, so that the cooked food can be heated up faster. As shown in FIG. 10, even when the moving assembly 630 is located in the second position, the fixed guide 642, the motor 671, etc. constituting the fixed assembly 640 may be fixed in original positions thereof without moving.

Meanwhile, FIG. 11 is a view showing a raising and lowering detection switch SW disposed at the insulation upper plate 270, which is in an ON state while being pressed. When the raising and lowering detection switch SW is provided to detect whether or not the moving assembly 630 is in the first position i.e., the initial location. Accordingly, whether the moving assembly 630 is raised or lowered can be detected. When the raising and lowering detection switch SW is in the first position, the raising and lowering detection switch SW may be turned into the ON state by being pressed by the moving assembly 630. When the raising and lowering detection switch SW is in the ON state, the processor 700 may determine that the moving assembly 630 is in the first position. When the moving assembly 630 is lowered from the first position to the lower side (the second position or a third position), the raising and lowering detection switch SW may be released from pressing to be turned into an OFF state. When the raising and lowering detection switch SW is in the OFF state, the moving assembly 630 may be in a state lowered from the first position. The processor 700 checks whether the raising and lowering detection switch SW is in the ON state or the OFF state to determine whether the moving assembly 630 is in the first position or is lowered. When the raising and lowering detection switch SW is in the ON state, the moving assembly 630 may be in the first position, i.e., the initial position, or may be lowered and returned to the first position.

As described above, when the raising and lowering detection switch SW is in the ON state, the processor 700 detects that the moving assembly 630 is in the first position and stops the motor 671. In other words, the processor 700 stops the motor 671 to prevent the moving assembly 630 from being further raised higher than the first position. In the embodiment, a raised height of the moving assembly 630 may be limited by the raising and lowering detection switch SW, and a lowered height of the moving assembly 630 may be limited by a revolution of the motor 671.

The raising and lowering detection switch SW is arranged at the insulation upper plate 270 or the fixed guide 642 so as to remain fixed regardless of movement of the moving assembly 630. In addition, the moving assembly 630 may include an operation pin P operating the raising and lowering detection switch SW by pressing it. The operation pin P may be arranged at the moving assembly 630, and be raised and lowered together with the moving assembly 630.

At this point, the raising and lowering detection switch SW may include an elastic drive part ED. The elastic drive part ED may be a part that is actually pressed by the operation pin P. When the operation pin P presses the elastic drive part ED, the elastic drive part ED may press the raising and lowering detection switch SW. Since the operation pin P has a pin shape with an upper end very narrow, a contact portion of the raising and lowering detection switch SW may not be precisely pressed. In the embodiment, the operation pin P presses a wide surface of the elastic drive part ED, and the elastic drive part ED presses again the raising and lowering detection switch SW, so that stable driving may be secured.

Both the raising and lowering detection switch SW and the elastic drive part ED may be provided at a switch bracket SB. The switch bracket SB may be arranged at the fixed assembly 640. In the embodiment, the switch bracket SB may be arranged at the fixed guide 642 of the fixed assembly 640.

As shown in FIG. 10, in the embodiment, two raising and lowering detection switches SW may be included in the second heat source module 600. The pair of the raising and lowering detection switches SW may be arranged adjacent to a pair of fixed guides 642. Even when one of the pair of raising and lowering detection switches SW is broken, but when the other raising and lowering detection switches SW is normally operated, the raising and lowering detection switches SW may detect that the moving assembly 630 is returned to the first position. Of course, only one raising and lowering detection switch SW may be provided.

Referring to FIG. 2, the cooking appliance may include the cooling fan module 810, 850. The cooling fan module 810, 850 is provided to cool the cooking appliance, and sucks outside air and supply the outside air into the cavity S, and the cooling fan module 810, 850 may suck outside air of the cooking appliance, and discharge air cooling the inside space of the cooking appliance outward. In the embodiment, the cooling fan module 810, 850 may include the first cooling fan module 810 and the second cooling fan module 850. The first cooling fan module 810 and the second cooling fan module 850 may be arranged at positions close to the upper portion of the cavity S rather than the lower portion of the cavity S.

The first cooling fan module 810 and the second cooling fan module 850 may be arranged on the insulation upper plate 270. At this point, the first cooling fan module 810 and the second cooling fan module 850 may be arranged around the second heat source module 600 with the second heat source module 600 as the center. The cooling fan module 810, 850 arranged above may cool the second heat source module 600 in various directions. The first cooling fan module 810 and the second cooling fan module 850 may be arranged in an orthogonal direction. The cooling fan modules 810 and 850 arranged above may provide a continuous flow path through which air flows.

Furthermore, the first cooling fan module 810 and the second cooling fan module 850 may discharge air toward different surfaces among surfaces of the inner casing 100. The first cooling fan module 810 may discharge toward a rear surface of the inner casing 100, more precisely, toward the third electric chamber ES3, and the second cooling fan module 850 may discharge air toward a side surface of the inner casing 100, more precisely, toward the fifth electric chamber ES5. The air discharged from the first cooling fan module 810 and the air discharged from the second cooling fan module 850 may meet in the second electric chamber ES2 and be discharged outward through the air outlet 243.

When the second heat source module 600 is located in the first position (referring to FIG. 9), the first cooling fan module 810 and the second cooling fan module 850 may cool the periphery of the heater housing 632. When the second heat source module 600 is located in the second position (referring to FIG. 10), the first cooling fan module 810 and the second cooling fan module 850 may cool the second heat source module 600 entire while passing through an upper portion of the second heat source module 600.

Referring to FIG. 4, the supply duct 910 may be arranged in the inner casing 100. The supply duct 910 is provided to cover the inlet port 123 of the inner casing 100. The supply duct 910 may provide a path through which air in the electric chamber is introduced into the cavity S. The air introduced into the cavity S through the supply duct 910 and the inlet port 123 may remove moisture in the cavity S. At this point, the air supplied through the inlet port 123 may be a part of air acting heat dissipation (cooling) while passing through the inside space of the casing 100, 200.

The supply duct 910 may be extended in a shape of which one end is bent. This shape is to prevent the supply duct 910 from interfering with the wave guide 420 of the first heat source module 400. In other words, the supply duct 910 may be arranged at one of the inner side plates 110 of the inner casing 100 where the wave guide 420 is arranged, and the supply duct 910 is arranged with a different height from the wave guide 420.

One end of the supply duct 910 may cover the inlet port 123, and a remaining portion thereof may be brought into close contact with the outer surface of the inner side plate 110 to provide a flow path in the inside space. The supply duct 910 may deliver air discharged from the first cooling fan module 810 to the inlet port 123, thereby facilitating air supply into the cavity S.

An exhaust duct 940 may cover the outlet port 125 of the inner casing 100. The exhaust duct 940 may be arranged in the fifth electric chamber ES5, and guide movement of air discharged from the outlet port 125. The exhaust duct 940 may be arranged on a surface of the inner side plate 110 in a gravity direction. Accordingly, air in the cavity S discharged through the outlet port 125 may move downward. The air moving downward may be guided to the second electric chamber ES2, and may be discharged to the air outlet 243 of the outer front plate 240.

The exhaust duct 940 may be arranged on one of the inner side plates 110 of the inner casing 100 where the processor 700 is discharged. In other words, the exhaust duct 940 and the processor 700 may be arranged on the same surface the inner side plate 110. At this point, the exhaust duct 940 may be arranged at a position farther from the door 300 than the processor 700. Therefore, air in the cavity S may be discharged from a rear portion of the casing 100, 200 far from the door 300, and in a process in which the air is discharged along the second electric chamber ES2, the air may cool the third heat source module 500 while passing through a lower portion of the third heat source module 500. The exhaust duct 940 may have an approximately vertically long shape.

For example, in the embodiment, the magnetron 410 is also arranged at a portion protruding from the inner side plates 110. Eventually, the magnetron 410 is arranged in the third electric chamber ES3, so that it is said that no heating element is arranged in the fourth electric chamber ES4. Therefore, even when an air barrier 950 blocks between the second electric chamber ES2 and the fourth electric chamber ES4, cooling of the heat sources can be efficiently performed.

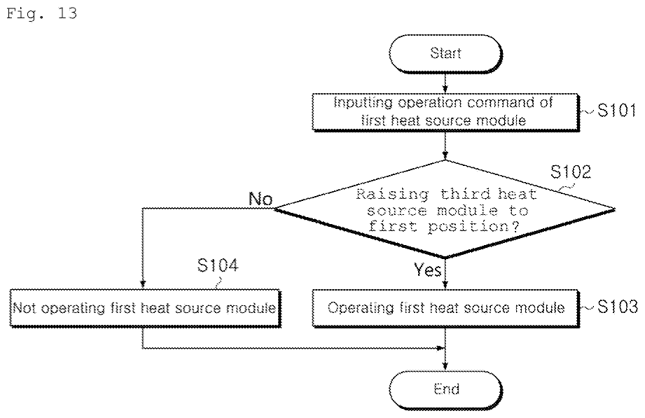

FIG. 12 is a block diagram showing a connection relationship between the processor and the components connected thereto that constitutes the cooking appliance according to the embodiment of the present disclosure.

The display module 350 may include the input part 351 and the display part 352. The input part 351 and the display part 352 may be implemented into the display module 350 as an integrated module. The input part 351 may receive an operation command of the cooking appliance from the user, and the display part 352 may display outward an operational state of the cooking appliance and a cooked state of food. The processor 700 may control an operation of the cooking appliance when an operation command of the cooking appliance is input from the input part 351. As an operation command of the cooking appliance, for example, an operation command of the first, second, third heat source module, a raising or lowering command of the second heat source module, etc. may be referred.

The processor 700 may control an operation of the first, second, third heat source module 400, 600, 500 and an operation of the motor 671 according to the ON/OFF state detected by the raising and lowering detection switch SW. As the motor 671 is driven, the link assembly 650 is operated to allow the moving assembly 630 to be raised and lowered. Furthermore, the processor 700 may turn ON/OFF the lighting part 165 when an operation command for the lighting part 165 is input.

Hereinbelow, a process of controlling an operation of the cooking appliance by the processor 700 will be described.

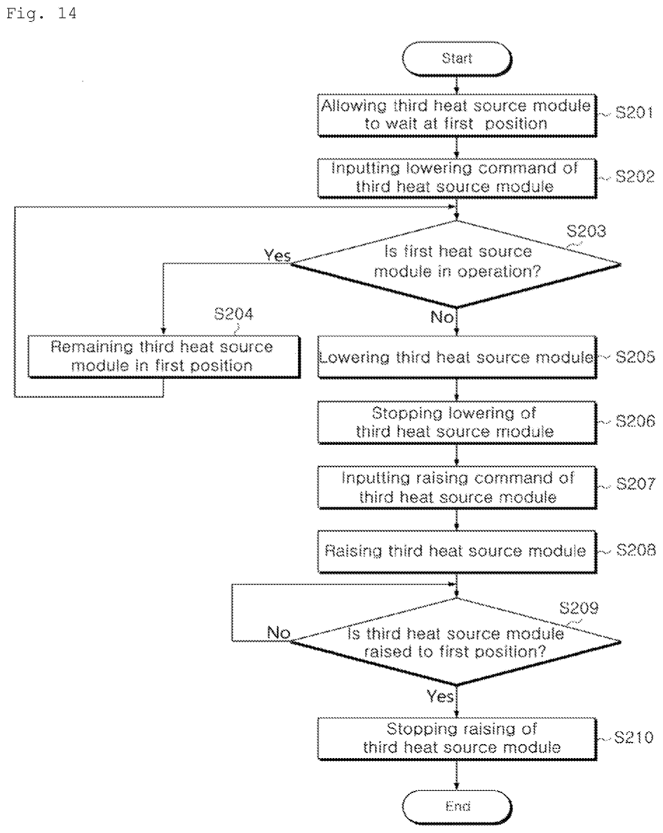

As shown in FIG. 13, when an operation command of the first heat source module 400 is input from the input part 351 at S101, the processor 700 determines whether or not the second heat source module 600 is raised to the first position, at S102. Raising and lowering of the second heat source module 600 substantially means raising and lowering of the moving assembly 630 where the plurality of heating units 610 is provided.

The processor 700 may determine whether the moving assembly 630 is raised or lowered from the ON/OFF signal transmitted from the raising and lowering detection switches SW. In other words, when the second heat source module 600 is raised to the first position, i.e., a preset initial position, the raising and lowering detection switches SW are pressed to be turned into the ON state. When the second heat source module 600 is lowered from the first position, the raising and lowering detection switches SW are released from the pressed state to be turned into the OFF state.

When the second heat source module 600 is raised, the processor 700 may allow the first heat source module 400 to be operated according to the operation command, at S103. However, when the second heat source module 600 is in a non-raised state, the processor 700 does not operate the first heat source module 400, at S104.

As described above, as shown in FIG. 13, as the embodiment of the cooking appliance, even when an operation command of the first heat source module 400 is input, the process allows operation of the first heat source module 400 only when the second heat source module 600 is raised, and prevents operation of the first heat source module 400 when the second heat source module 600 is lowered.

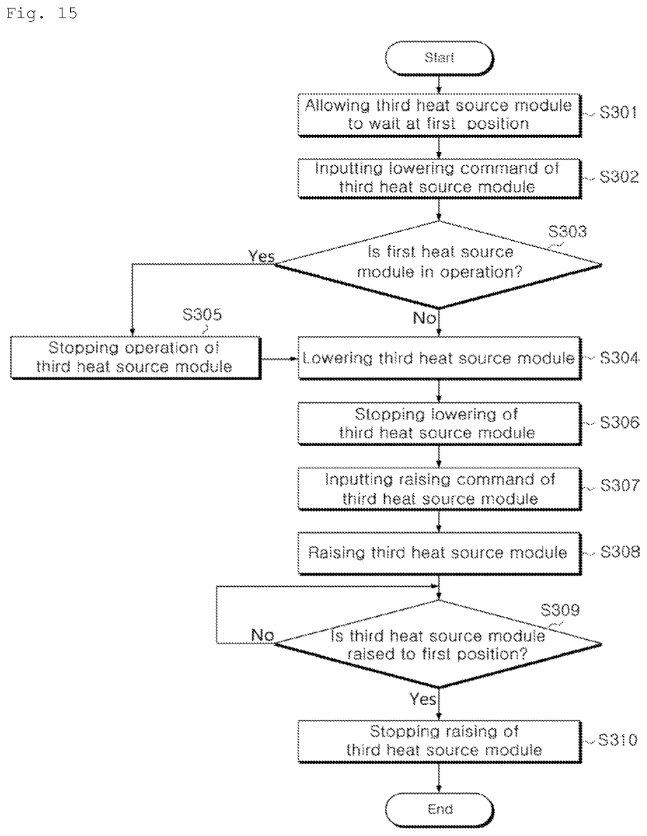

As shown in FIG. 14, when the second heat source module 600 is raised to the first position and waits, at S201, and a lowering command of the second heat source module 600 is input, at S202, the processor 700 may determine whether or not the first heat source module 400 is in operated, at S203. In the determination, when the first heat source module 400 is in operation, the processor 700 does not operate the link assembly 650 to allow the second heat source module 600 to continue to wait in the first position, at S204. In the determination, when the first heat source module 400 is not operated, the processor 700 operates the link assembly 650 to allow the second heat source module 600 to be lowered from the first position, at S205. At this point, the second heat source module 600 may be lowered to the second position, i.e., a middle position, or the third position, i.e., the lowest position. When the second heat source module 600 reaches the second position or the third position, the processor 700 stops the link assembly 650 to stop lowering of the second heat source module 600, at S206.

When a raising command of the second heat source module 600 is input while the second heat source module 600 is lowered, at S207, the processor 700 operates the link assembly 650 to raise the second heat source module 600, at S208. When the processor 700 determines that the second heat source module 600 has been raised to the first position, at S209, the processor 700 stops the link assembly 650 to stop raising of the second heat source module 600, at S210. At this point, when the raising and lowering detection switches SW are in the ON state, the processor determines that the second heat source module 600 has been raised to the first position.

As described above, in FIG. 14, as another embodiment of the cooking appliance, even when a lowering command of the second heat source module 600 is input, when the first heat source module 400 is operated, the second heat source module 600 may not be lowered, and only when an operation of the first heat source module 400 is stopped, the second heat source module 600 may be lowered.

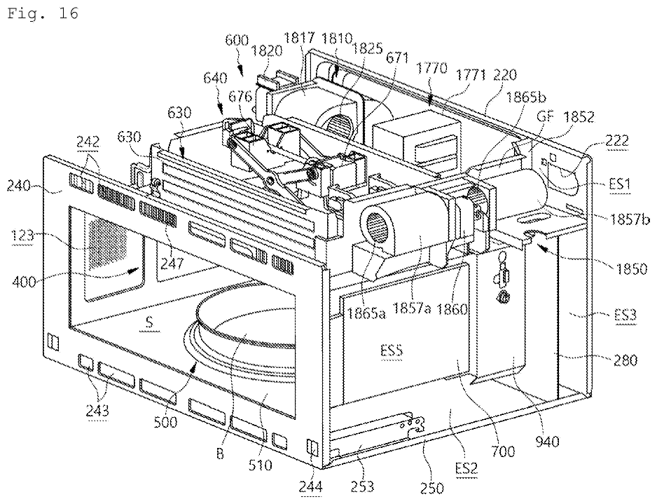

As shown in FIG. 15, while the second heat source module 600 is raised to the first position and waits at S301, when a lowering command of the second heat source module 600 is input at S302, the processor 700 may determine whether or not the first heat source module 400 is operated at S303. When the first heat source module 400 is not operated in the determination, the processor 700 operates the link assembly 650 to allow the second heat source module 600 to be lowered from the first position at S304. When the first heat source module 400 is operated in the determination, the processor 700 stops operation of the first heat source module 400 at S305. Thereafter, the processor 700 operates the link assembly 650 to allow the second heat source module 600 to be lowered from the first position at S304. When the second heat source module 600 reaches the second position or the third position, the processor 700 stops operation of the link assembly 650 so that lowering of the second heat source module 600 is stopped at S306.

While the second heat source module 600 is lowered, when a raising command of the second heat source module 600 is input at S307, the processor 700 operates the link assembly 650 to raise the second heat source module 600 at S308. When the processor 700 determines that the second heat source module 600 is raised to the first position, at S309, the processor 700 stops operation of the link assembly 650 to stop raising of the second heat source module 600 at S310.

As described above, in FIG. 15, according to another embodiment of the cooking appliance, when a lowering command of the second heat source module 600 is input, when the first heat source module 400 is operated, the operation of the first heat source module 400 is stopped and then the second heat source module 600 is lowered.

FIGS. 16 to 21 are views showing the cooking appliance according to another embodiment of the present disclosure. In FIGS. 16 to 21, in addition to the first heat source module 400 to the second heat source module 600 described above, the cooking appliance includes a fourth heat source module 1100. The fourth heat source module 1100 is arranged at the rear surface of the casing 100, 200. In addition, a power supply 1770 is arranged on an upper surface of the casing 100, 200, not the rear surface of the casing 100, 200. Hereinbelow, the same reference numerals are given to the same structures as in the previous embodiment, detailed descriptions are omitted, and a structure different from the previous embodiment will be described.

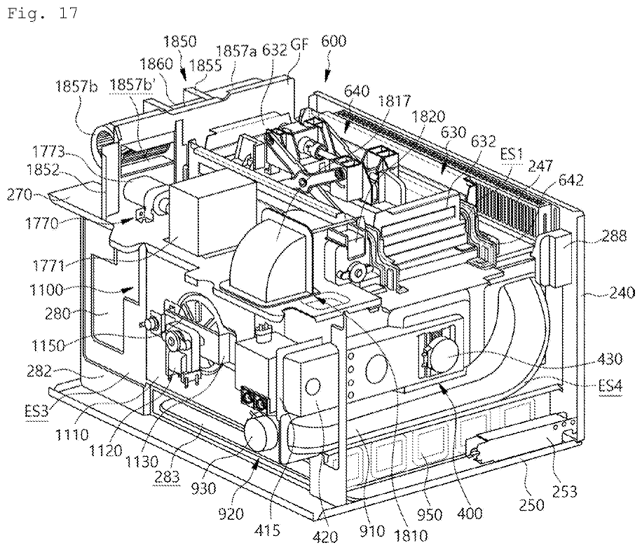

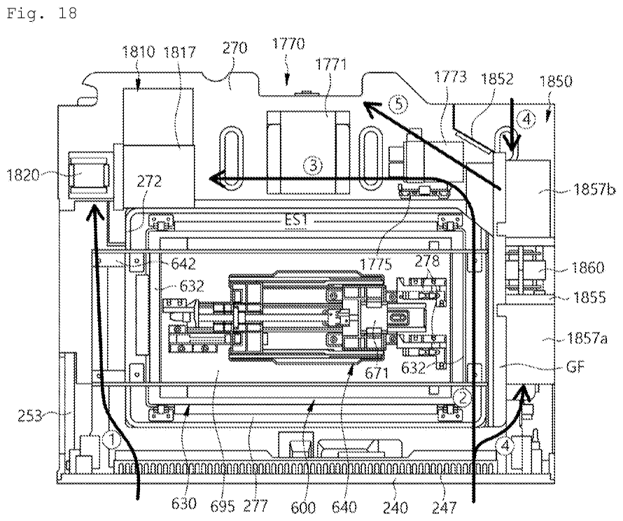

As shown in FIGS. 16 and 17, the views show that the power supply 1770 is arranged on the insulation upper plate 270. The power supply 1770 includes a high voltage transformer 1771, and the high voltage transformer 1771 has relatively large volume and generates high temperature heat. Accordingly, it is important to efficiently cool the high voltage transformer 1771.

For reference, in FIG. 16, the view shows the outer rear plate 220, but in FIG. 17, the outer rear plate 220 is omitted in the view. In FIG. 16, the fourth heat source module 1100 may be arranged in the third electric chamber ES3 provided between the outer rear plate 220 and the insulation rear plate 280. As shown in FIG. 17, the view shows that the fourth heat source module 1100 is provided at the insulation rear plate 280 arranged in front of the outer rear plate 220. The fourth heat source module 1100 may be a convection heater. In other words, the fourth heat source module 1100 may provide heat for convection-heating of cooked food in the cavity S.

As described above, in the embodiment, the first heat source module 400, the third heat source module 500, the second heat source module 600, and the fourth heat source module 1100 may be respectively arranged in the electric chambers differently from each other in the casing 100, 200. In other words, it may be said that the first heat source module 400, the third heat source module 500, the second heat source module 600, and the fourth heat source module 1100 is arranged at different surfaces of the casing 100, 200 from each other. Furthermore, the plurality of heat sources may be composed of different types of heat sources. Accordingly, the plurality of heat sources may provide different types of heating means to the cooked food in different directions.

The fourth heat source module 1100 may be a kind of convection heater. The fourth heat source module 1100 may generate convection heat inside the cavity S together with a convection fan, thereby improving the uniformity of the cooked food. Otherwise, the convection fan may be omitted in the fourth heat source module 1100, and the fourth heat source module 1100 may provide radiant heat to cooked food by using a heating wire like the third heat source module 600.

As shown in FIG. 17, the fourth heat source module 1100 includes a convection housing 1110. The convection housing 1110 may be arranged at the insulation rear plate 280, and a convection chamber may be provided inside the convection housing 1110, and a convection heater (not shown) may be arranged in the convection chamber. The convection heater may have a bar type form having a predetermined length and a predetermined diameter. For example, the convection heater may be a sheath heater with a metal protection tube of the heating wire. Otherwise, the convection heater may be a carbon heater, a ceramic heater, and a halogen heater, in which a filament is sealed inside a tube made of a transparent or translucent material.

A motor bracket 1130 may be arranged in the convection housing 1110, and a convection motor 1120 may be mounted to the motor bracket 1130. The convection motor 1120 may rotate the convection fan (not shown) in the convection housing 1110 When the convection fan is rotated by the convection motor 1120, heat of the convection heater may heat cooked food while performing convection inside the cavity S. Reference numeral 1150 indicates an outlet through which heat in the convection chamber is discharged to the outside space.

When operation of the fourth heat source module 1100 is input, power is applied to the convection motor 1120 to rotate the convection fan, and power is applied to the convection heater to heat the convection heater. Therefore, the convection fan generates forced convection between the cavity S and the convection chamber in the convection housing 1110, and the forced convection by the convection fan is changed into hot air by receiving heat from the convection heater, so that the temperature in the cavity S may be increased and cooked food may be heated.

FIG. 16 is a view showing a first cooling fan module 1810. The first cooling fan module 1810 may be arranged on the insulation upper plate 270. The first cooling fan module 1810 may include a first fan housing 1817. A first fan motor 1820 may be provided at one portion of the first fan housing 1817. A shaft (not shown) may be connected to the first fan motor 1820, and the shaft may be coupled to a first fan blade 1825.

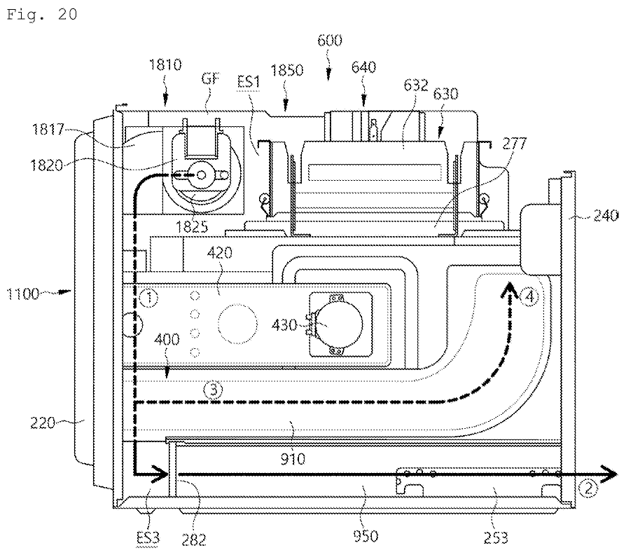

The first fan blade 1825 may discharge air downward, i.e., in the direction of gravity. As shown in FIG. 19, air is discharged downward from the first cooling fan module 1810. The discharged air may be discharged into the third electric chamber ES3. Since the fourth heat source module 1100 and the magnetron 410 of the first heat source module 400 are arranged in the third electric chamber ES3, the first cooling fan module 1810 may cool the fourth heat source module 1100 and the magnetron 410.

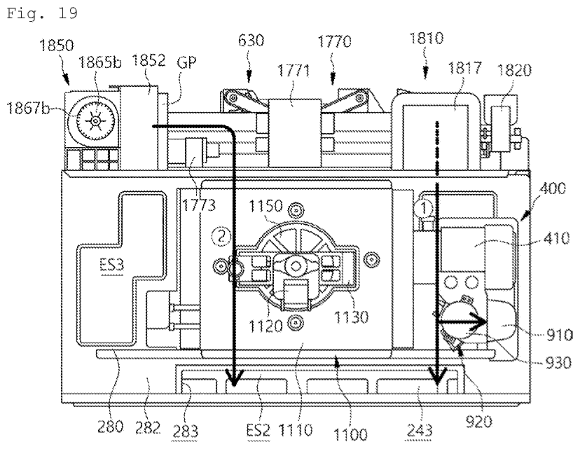

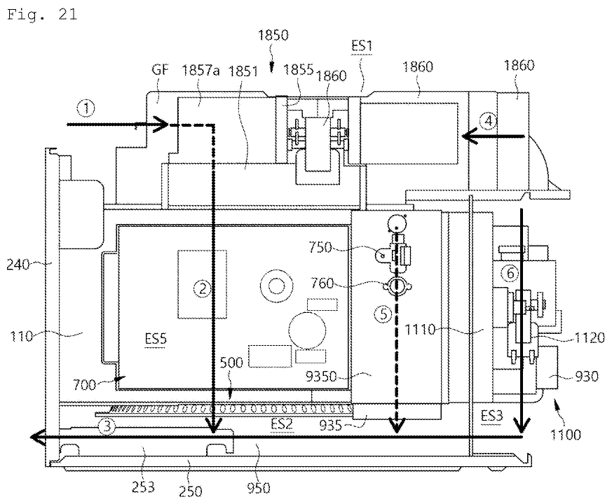

Furthermore, air discharged from the first cooling fan module 1810 may pass through the third electric chamber ES3, and flow downward to be introduced into the second electric chamber ES2. In addition, as shown in FIGS. 19 and 20, a part of air discharged from the first cooling fan module 1810 may move forward, toward the door 300 (direction of arrow 3 in FIG. 18), along the supply duct 910, and the air may be guided toward the inside space of the cavity S (direction of arrow).

Referring to FIG. 16 again, a second cooling fan module 1850 is shown in the drawing. The second cooling fan module 1850 may cool the cooking appliance like the first cooling fan module 1810, and may allow inside air to be efficiently supplied into the cavity S. Looking at the structure of the second cooling fan module 1850, the second cooling fan module 1850 may include a second fan housing 1857a, 1857b forming a frame, and a second fan motor 1860 arranged at one portion of the second fan housing 1857a, 1857b.

The second fan housing 1857a, 1857b may include a first drive housing 1857a and a second drive housing 1857b that are arranged at opposite sides thereof. The second fan motor 1860 may be arranged between the first drive housing 1857a and the second drive housing 1857b. A shaft (not shown) may be connected to the second fan motor 1860, and the shaft may be coupled to a pair of second fan blades 1865a and 1865b. The shaft may be extended in opposite directions from the second fan motor 1860, and the pair of second fan blades 1865a and 1865b may be respectively coupled to opposite portions of the shaft.

At this point, the pair of second fan blades 1865a and 1865b may be respectively arranged in the first drive housing 1857a and the second drive housing 1857b. In addition, one 1865a of the pair of second fan blades 1865a and 1865b may discharge air in the direction of gravity, and the other 1865b may discharge air in a direction perpendicular to the direction of gravity, i.e., toward the first electric chamber ES1. As shown in FIG. 21, the first drive housing 1857a may be open downward, so that the second fan blade 1865a provided in the first drive housing 1857a may discharge air downward (direction of arrow 2). Accordingly, the processor 700 arranged in the fifth electric chamber ES5 may be cooled.

Meanwhile, referring to FIG. 17, an outlet 1857b′ of the second drive housing 1857b may be open toward the first electric chamber ES1. Accordingly, the second fan blade 1865b arranged in the second drive housing 1857b may discharge air toward the first electric chamber ES1 through the outlet 1857b′ of the second drive housing 1857b, more precisely, toward the power supply 1770. Accordingly, the second cooling fan module 1850 may cool the power supply 1770.

The air cooling the power supply 1770 may flow downward. As shown in FIG. 21, air is introduced in an inward direction of the second drive housing 1857b (arrow 4), and then may flow toward the third electric chamber ES3 through the power supply 1770 (arrow 6). In addition, in this process, the fourth heat source module 1100 may be cooled.

FIGS. 18 to 21 are views showing an air circulation structure in the cooking appliance according to the embodiment. Since the cooking appliance according to the embodiment includes the first heat source module 400, the third heat source module 500, the second heat source module 600, and the fourth heat source module 1100, there is a need to efficiently lower heat generated from each heat source. Hereinbelow, a cooling structure of the heat sources and other parts will be described.

First, describing parts required to be cooled in the embodiment, (i) in the first electric chamber ES1, there is a need to cool a lighting fixture 790, the distance sensor 710, the second heat source module 600, a third temperature sensor (not shown), and the power supply 1770, (ii) in the second electric chamber ES2, there is a need to cool the third heat source module 500, (iii) in the third electric chamber ES3, there is a need to cool the fourth heat source module 1100 and the camera module 730, (iv) in the fifth electric chamber ES5, there is a need to cool the processor 700, a humidity sensing module 750, a second temperature sensor 760, and a temperature block switch (not shown).

In addition, in order to cool the parts, the cooking appliance of the embodiment includes the first cooling fan module 1810 and the second cooling fan module 1850 described above. The first cooling fan module 1810 may cool the second electric chamber ES2 and the third electric chamber ES3, and the second cooling fan module 1850 may cool the first electric chamber ES1, the second electric chamber ES2, and the fifth electric chamber ES5. Of course, since the first cooling fan module 1810 is also arranged at the upper portion of the casing 100, 200, the first cooling fan module 1810 may cool a part of the first electric chamber ES1. Furthermore, since the first cooling fan module 1810 discharge air toward a duct assembly 920 arranged at the third electric chamber ES3, the first cooling fan module 1810 may serve to supply air into the cavity S.

Specifically, as shown in FIG. 16, in the embodiment, the air inlet part 242 sucking external air and the air outlet part 243 through which air is discharged again are arranged at a front surface of the cooking appliance. The external air may be introduced into an upper portion of the front surface of the cooking appliance and circulate the inside space of the cooking appliance and then be discharged through a lower portion of the front surface again. Therefore, even when the cooking appliance of the embodiment is installed in a built-in manner, efficient air circulation may be performed.

Furthermore, as shown in FIGS. 16 and 17, the plurality of electric chambers may be provided outside the inner casing 100 of the embodiment, and air may efficiently cool the parts while flowing the electric chambers. At this point, the air barrier 950 may prevent air introduced into the second electric chamber ES2 from flowing upward again through the fourth electric chamber ES4, and eventually, the air may cool the third heat source module 500 in the second electric chamber ES2 and then move forward to flow through the air outlet 243.

In addition, in the embodiment, the insulation upper plate 270 and the insulation rear plate 280 may be respectively arranged outside the inner casing 100 to prevent heat in the cavity S from being directly transferred to the parts. It may be said that the insulation upper plate 270 and the insulation rear plate 280 serve as a cooking function of the cooking appliance, together with the first cooling fan module 1810 and the second cooling fan module 1850.

As shown in FIG. 16, the first cooling fan module 1810 may be arranged at the insulation upper plate 270, more specifically, may be arranged at a position of biasing it to the third electric chamber ES3 and the fourth electric chamber (ES4, left surface of drawing) from a center portion of the insulation upper plate 270. In addition, the second cooling fan module 1850 is also arranged at the insulation upper plate 270, more precisely, the second cooling fan module 1850 may be arranged at a position where the second cooling fan module 1850 is biasing toward the center of the fifth electric chamber ES5 from the insulation upper plate 270.

As shown in FIG. 18, the view shows flows of air sucked by the first cooling fan module 1810 and the second cooling fan module 1850. Air sucked through the outer front plate 240 may flow into the first cooling fan module 1810. At this point, air may be introduced toward the first cooling fan module 1810 in two streams. At this point, air introduced to the left side of the first cooling fan module 1810 (direction of arrow 1) may flow along between the heater housing 632 of the second heat source module 600 and the outer upper plate 230 (omitted in FIG. 16) arranged at a left edge of the casing 100, 200. In addition, air introduced to the right side (direction of arrow 2) of the first cooling fan module 1810 may flow along between the heater housing 632 of the second heat source module 600 and a guide fence GF.

As described above, in the process in which air is sucked into the first cooling fan module 1810, the distance sensor 710, the lighting fixture 790, and the second heat source module 600 may be cooled. Furthermore, the power supply 1770 arranged on the flow path of air may also be cooled. Arrow 3 shows a direction in which air sucked into the first cooling fan module 1810 passes through the power supply 1770. Accordingly, the power supply 1770 may be cooled by the first cooling fan module 1810.

Simultaneously, the second cooling fan module 1850 may also suck external air through the outer front plate 240. Air introduced toward the second cooling fan module 1850 (direction of arrow 4) may cool the first electric chamber ES1 while flowing toward the second cooling fan module 1850. At this point, two streams of air may be sucked toward the first drive housing 1857a and the second drive housing 1857b included in the second cooling fan module 1850. Among the two streams of air, air sucked toward the first drive housing 1857a may be introduced through the air inlet part 242 of the outer front plate 240, and cool the front portion of the first electric chamber ES1 closer to the door 300.

In addition, air sucked by the first cooling fan module 1810 and air sucked by the second cooling fan module 1850 may flow downward of the cooking appliance. Referring to FIG. 19, air sucked by the first cooling fan module 1810 is discharged downward, in other words, toward the third electric chamber ES3 (direction of arrow 1). In this process, the magnetron 410 of the first heat source module 400 may be cooled. Since the magnetron 410 constituting the first heat source module 400 is arranged at a lower portion of the first cooling fan module 1810, air discharged downward (direction of arrow (1) from the first cooling fan module 1810 may cool the magnetron 410 while flowing. In addition, air flowing through the third electric chamber ES3 may be introduced into the second electric chamber ES2 through a ventilation part 283 provided at the lower portion of the insulation rear plate 280.

Meanwhile, as shown in FIG. 21, air sucked into the first drive housing 1857a of the second cooling fan module 1850 may also be discharged downward, in other words, toward the fifth electric chamber ES5 (direction of arrow 4). In this process, the processor 700, and the humidity sensing module 750 and the second temperature sensor 760 arranged at the exhaust duct 940 may be cooled. Specifically, since the processor 700 generating high temperature heat may be arranged below the first drive housing 1857a, the processor 700 may be efficiently cooled.

Next, air flowing through the fifth electric chamber ES5 may be introduced into the second electric chamber ES2, and air cooling the third heat source module 500 in the second electric chamber ES2 may be discharged outward through the air outlet 243 (direction of arrow 3).

Meanwhile, air sucked into the second drive housing 1857b of the second cooling fan module 1850 may be discharged horizontally, not the direction of gravity. More specifically, as shown in FIG. 19, air sucked into the second drive housing 1857b may be discharged toward the first electric chamber ES1 through the outlet 1857b′ (referring to FIG. 17) of the second drive housing 1857b, in other words, toward the power supply 1770. Accordingly, the second cooling fan module 1850 may cool the power supply 1770.

The air cooling the power supply 1770 may flow downward. As shown in FIG. 19, air discharged from the second drive housing 1857b may be discharged toward the power supply 1770, and then flow downward to the third electric chamber ES3 (arrow 2). In addition, in this process, the fourth heat source module 1100 may be cooled. Air flowing through the fourth heat source module 1100 may be finally introduced into the second electric chamber ES2 and then flow forward to be discharged through the air outlet 243.

As shown in FIG. 21, air may be transferred to the second electric chamber ES2 also through the exhaust duct 940. The exhaust duct 940 may guide air discharged from the cavity S downward (direction of arrow 5), thereby transferring the air into the second electric chamber ES2. In addition, the air discharged from the cavity S may also be discharged outward through the air outlet 243 (direction of arrow 3).

At this point, air introduced into the second electric chamber ES2 through the first cooling fan module 1810 and the second cooling fan module 1850 may flow forward only, and is prevented from being introduced into the fourth electric chamber ES4 again. This is because the air barrier 950 is arranged below the fourth electric chamber ES4. As shown in FIG. 21, the air barrier 950 may guide air forward.

FIG. 20 is a view showing the fourth electric chamber ES4. As shown in the drawing, the wave guide 420 constituting the first heat source module 400 and the supply duct 910 may be arranged in the fourth electric chamber ES4. Air discharged downward of the first cooling fan module 1810 (arrow (1) may be introduced into the supply duct 910. At this point, although not shown in FIG. 20, when the duct assembly 920 provided in the supply duct 910 is opened, air discharged from the first cooling fan module 1810 may be introduced into the supply duct 910 through the duct assembly 920. Air flowing forward along the supply duct 910 (direction of arrow 3)) may be introduced into the cavity S through the inlet port. Arrow 4 shows a moving direction of air introduced into the cavity S. In FIG. 20, arrow 20 shows a direction in which air discharged from the first cooling fan module 1810 and introduced into the second electric chamber ES2 flows along the opposite portion of the air barrier 950.

Through the flows of air as described above, the first heat source module 400 to the fourth heat source module 1100, the power supply 1770, the magnetron 410, the processor 700, etc. may be cooled. Furthermore, the flow paths of the embodiment may prevent air from flowing backward, and may guide air in a constant direction to allow efficient cooling. Specifically, in the embodiment, even without a separate tubular structure is not provided, a flow of air may be generated by using a gap between the parts.

Although the preferred embodiments of the present disclosure have been described for illustrative purposes, those skilled in the art will appreciate that various modifications, additions and substitutions are possible, without departing from the scope and spirit of the present disclosure as disclosed in the accompanying claims. Therefore, the preferred embodiments described above have been described for illustrative purposes, and should not be intended to limit the technical spirit of the present disclosure, and the scope and spirit of the present disclosure are not limited to the embodiments. The protective scope of the present disclosure should be interpreted by the accompanying claims, and all technical spirits within the equivalent scope should be interpreted as being included in the scope and spirit of the present disclosure.

1. A cooking appliance comprising:
a casing having a cavity therein;
a door provided at the casing, and configured to open and close the cavity;
a first heat source module arranged at a side surface of the casing;
a second heat source module arranged at an upper portion of the casing; and
a processor controlling operations of the first and second heat source modules,
wherein the second heat source module comprises a fixed assembly fixed to the upper portion of the casing, a moving assembly with a heating unit emitting heat, and a link assembly connected to the fixed assembly and the moving assembly while being located therebetween and configured to raise and lower the moving assembly.

2. The cooking appliance of claim 1, wherein when a raising or lowering command of the moving assembly is input, the processor operates the link assembly to raise and lower the moving assembly.

3. The cooking appliance of claim 1, further comprising:
a raising and lowering detection switch detecting whether the moving assembly is raised or lowered.

4. The cooking appliance of claim 3, wherein when the raising and lowering detection switch detects lowering of the moving assembly, the processor stops operation of the first heat source module.

5. The cooking appliance of claim 3, wherein, when an operation command of the first heat source module is input, the processor operates the first heat source module in case where the raising and lowering detection switch detects raising of the moving assembly.

6. The cooking appliance of claim 3, wherein when the raising and lowering detection switch detects that the moving assembly is lowered and then raised again, the processor stops operation of the link assembly.

7. The cooking appliance of claim 1, wherein the first heat source module emits microwaves toward the cavity.

8. The cooking appliance of claim 1, wherein the second heat source module emits radiant heat toward the cavity.

9. The cooking appliance of claim 1, further comprising:
a third heat source module emitting magnetic fields toward the cavity.

10. A control method of a cooking appliance comprising a first heat source module and a second heat source module, which are respectively provided at a side surface and an upper portion of a casing having a cavity therein, the control method comprising:
inputting an operation command of the first heat source module;
determining whether the second heat source module is raised or lowered; and
when the second heat source module is raised to a preset initial position, operating the first heat source module.

11. The control method of claim 10, wherein when the second heat source module is lowered from the initial position, the first heat source module is not operated.

12. The control method of claim 10, wherein the first heat source module emits microwaves toward the cavity.

13. The control method of claim 10, wherein the second heat source module emits radiant heat toward the cavity.

14. A control method of a cooking appliance comprising a first heat source module and a second heat source module, which are respectively provided at a side surface and an upper portion of a casing having a cavity therein, the control method comprising:
raising the second heat source module to a preset initial position and allowing the second heat source module to wait;
inputting a lowering command of the second heat source module;
determining whether or not the first heat source module is operated; and
when the first heat source module is operated, allowing the second heat source module to continue to wait at the initial position, and when the first heat source module is in a non-operated state, lowering the second heat source module.

15. The control method of claim 14, further comprising:
after the lowering of the second heat source module,
inputting a raising command of the second heat source module;
raising the second heat source module;
determining whether or not the second heat source module is raised to the initial position; and
when the second heat source module is raised to the initial position, stopping raising of the second heat source module.

16. A control method of a cooking appliance comprising a first heat source module and a second heat source module, which are respectively provided at a side surface and an upper portion of a casing having a cavity therein, the control method comprising:
raising the second heat source module to a preset initial position and allowing the second heat source module to wait;
inputting a lowering command of the second heat source module;
determining whether or not the first heat source module is operated;
when the first heat source module is operated, stopping operation of the first heat source module; and
lowering the second heat source module.

17. The control method of claim 16, further comprising:
after the lowering of the second heat source module,
inputting a raising command of the second heat source module;
raising the second heat source module;
determining whether or not the second heat source module is raised to the initial position; and
when the second heat source module is raised to the initial position, stopping raising of the second heat source module.
